(19) United States
(12) Patent Application Publication
(10) Pub. No.: US 2014/0032378 A1
(43) Pub. Date: Jan. 30, 2014

(54) PRODUCT AUTHENTICATION PROCESS AND SYSTEM FOR PREVENTING COUNTERFEITING AND PIRACY IN MARKET DISTRIBUTION CHANNELS

(71) Applicants: Budimir Damnjanovic, Livonia, MI (US); Desanka Damnjanovic, Livonia, MI (US)

(72) Inventors: Budimir Damnjanovic, Livonia, MI (US); Desanka Damnjanovic, Livonia, MI (US)

(21) Appl. No.: 13/562,185

(22) Filed: Jul. 30, 2012

(51) Int. Cl. G06Q 10/08; G06F 17/30

(52) U.S. Cl. 705/28

(57) ABSTRACT

The present invention provides a product authentication process and system for detecting the distribution of unauthorized product. In one exemplary embodiment the process includes the step of inputting product information of a plurality of products into an internet accessible database, the product information including identification information of the plurality of products. The method further includes the step of inputting distribution information of the plurality of products into the internet accessible database, the distribution information including locations of the plurality of products along a distribution chain. The method further comprises the step of providing a search engine data server for searching and viewing the identification information and distribution information of the plurality of products. The method further includes the step of generating an alarm if there is a difference between product information or distribution information inputted into the internet searchable database and actual product information or distribution information.

### FIELD OF THE INVENTION

The present invention relates generally to product authentication processes, methods and systems utilizing continuous and detailed listing and tracking of products, their manufacturers, distributors and retailers on a world wide web's vast archival commercial data bases in “real time” and in a manner which ensures that only non-counterfeit, bona fide products, product manufacturers, distributors and retailers are authenticated, certified and listed.

### BACKGROUND

Throughout this invention the term “customer” carries a broad meaning, depending on the point in the distribution chain in which the purchase is being made. For a final purchase where no additional modification or value adding process is involved, the customer is usually an individual, corporate or governmental “final consumer”. At various other times the customer can be a wholesaler, broker, consolidator, re-packager, institutional buyer, government and private manufacturer who adds value to the products by using them in other products. The terms “consumer”, “customer” and “end-user” are construed herein as synonymous and interchangeable. Similarly, the terms “retailer” and “seller” are interchangeable; “manufacturer” and “brand name owner” are interchangeable; “distributor” and “wholesaler” are also interchangeable. Similarly, the term “vendor” is a general term for supplier and interchangeable with wholesaler, distributor, broker, consolidator, re-packager, retailer or seller.

Counterfeit, tainted and pirated product trademarks and infringed patents are rampant world-wide. These illicit products range from common everyday consumer goods such as, for example: golf equipment, watches, jewelry, purses, apparel, cosmetics and toiletries. These illicit products can also be found in very expensive brand name consumer and institutional articles, critical safety and performance-related automotive and high-tech aviation components for both the civilian and military applications, nuclear industry, driver licenses and other personal identification documents, nation's currencies, coins, popular and mission-critical military and commercial grades of IC chips, computer hardware and software, health supplements, pharmaceuticals, security application holograms and numerous medical items. Since the counterfeit, tainted and pirated products could be secretly introduced anywhere in a distribution or sales channel and cover very wide spectrum of goods at various pricing levels, they undermine the finances, health and safety of a wide range of bona fide manufacturers, distributors, consumers and the general public. In addition, since the problem of product tampering is closely related to product tainting and counterfeiting when pertaining to pharmaceuticals and items intended for ingestion, it will be incorporated and treated by this invention as an integral part of the broader anti-counterfeit process.

Many counterfeit and tainted products are surreptitiously produced without the knowledge of the brand owner, in the same production facilities which produce the original and authentic products, but using inferior or hazardous materials and workmanship. Sometimes, also, as the result of allowing military buyers to make off-the-shelf procurements from the lowest bidder of unknown origin in effort to meet required delivery schedules and costs, without regard for the system risk, counterfeit computer chips fabricated overseas in potentially hostile countries are provided and designed to fail prematurely or designed to supply surveillance and tracking capability or to provide a “back door” to slip past the network fire walls of a country's military system. It is prohibitively expensive and time consuming to test each of such complex chips to assure that they are tamper-free. Of all the counterfeit and tainted products distributed in the United States domestic market, the vast number of these fake products are smuggled or imported into this country from countries where the counterfeiting of goods, including military grade components, is largely ignored, tolerated or encouraged by the government as a matter of economic or foreign policy. While much of counterfeit and pirated consumer products are clearly directed for final and non-hazardous customer's self-actualization, status or vanity, an appreciable number of such products clearly present life or death, health and safety concerns.

In addition to outright product counterfeiting and piracy, there are also five additional types of consumer fraud which are closely related to product counterfeiting. These five additional types are: (a) “spelled-alike products”; (b) “gray market diversion”; (c) “fencing” or re-selling of stolen genuine products; (d) “on-line brand abuse”; and (e) “content farming”, whereby a book or any written article on the Internet blog is scanned or copied by scammers and sold on eBook sites under multiple scammer identities for good review without even attributing original authorship or owning a copyright.

In addition to inflicting increasingly onerous financial loses to the bona fide creators, manufacturers, distributors and retailers from stolen revenue, trademark, copyright and patent infringement, loss of manufacturer's reputation or good will and market integrity, the counterfeit products continue to pose the following additional problems: (1) Increased safety and health hazard issues arising from non-effective and lethal supplements and medications as result of ineffective or hazardous materials, adulteration, dilution, misbranding, shoddy and unregulated workmanship delivered to the final consumers and consumer-producers, which also include institutional and governmental agencies. (2) Increased use of malicious software or malware from on-line commerce. For example, the latest twist in the commerce of counterfeit pharmaceuticals are the advertisements on the Internet, directed at consumers who are interested in saving money through self-medication or simply trying to obtain cheaper medication than what is charged by the local pharmacy. Typically, the medication which normally requires a doctor's prescription, is sold in this way without requiring a prescription. Not only are these consumers risking their health and lives to questionable formulation and preparations from unknown manufacturing, distribution and retailing sources, but they are also infecting their computers with malware programs which frequently originate from such web sites. (3) Increased cost to the taxpayers for the employment of additional customs agents and inspectors, higher costs of products to the final consumers due to genuine manufacturers', distributors' and sellers' revenue losses, increased insurance rates and expenses for defensive and legal actions and liabilities in effort to protect themselves and the product brand. (4) Increased revenue stream that accrues to the counterfeiters which in many cases goes to fund criminal and terrorist syndicates. (5) Increased cost of recalling counterfeit products by bona fide manufacturers for testing and verifying whether it is or not their genuine product. (6) Loss of domestic jobs and tax revenues to the bona fide manufacturing. (7) Threat to the national security from counterfeit military and commercial equipment components.

Further, in addition to the plurality of counterfeit and tainted cases in the United States, it is extremely difficult or almost impossible for the average consumers to discern or differentiate counterfeit products from original authentic and proprietary products without specialized training, special and expensive testing or detection equipment. Counterfeiting methods are becoming more complex and difficult to track, affecting almost every product and every nation. This situation is even more pronounced in less technologically advanced markets.

Further, it is difficult in many cases, even in the United States, for distributors or their retailers to differentiate between genuine products and counterfeit products if: (a) there is no clear cut, direct and authoritative distribution channel and documentation trail back to the bona fide manufacturer, or (b) if the products are procured from undocumented, non-certified or fraudulent bargain-bin part brokers who obtained their parts from unknown sources, and the third-party sources during supply shortages or product-life termination by the manufacturer, thus making tracking the product very difficult. This situation is even more pronounced in less technologically advanced markets. Accordingly, there is an urgent need to detect and track products sold to anyone, anywhere in the world market in such a way that the counterfeit, tainted and pirated products can be identified and differentiated from the genuine and bona fide products very quickly, simply, reliably, unambiguously and economically.

To counter increasing financial losses to the bona fide manufacturers, distributors and retailers along with addressing health and safety concerns for the customers and the general public due to product falsification, label and trademark manipulation, from both the domestic and international counterfeiters, the legitimate manufacturing industry and their respective trade organizations have implemented a wide array of ingenious and sophisticated product authentication methods, both overt and covert, to combat the fake, qualitatively inferior and unsafe materials, component parts and complete manufactured items. Some of these aforementioned anti-counterfeit methods, indicated here in part for illustrative purpose, include: Call In the Numeric Token (CNT) used for pharmaceuticals; smart/intelligent packaging; temper—evident stickers and packaging; shrink wrapping; 2D and 3D bar coding; color coding; thermo-chromic inks; photo-chromic inks; IR phosphorescent inks; numbering; personalization; micro-texting; UV technique involving the introduction of various fluorescing taggants singly or in combination; watermarks; holograms; hard to match colors; random and unpredictable ID and RFID tags; secure serialization systems; and randomly or pseudo-generated numeric or semi-numeric symbolic tokens and some others as indicated in the SEMI Technical Standards, such as SEMI T20 and its associated subordinate standards SEMI T20.1 and SEMI T20.2. Many of these aforementioned anti-counterfeit methods work in some cases, while some of these indicated methods like the RFID tags for example, have proved to be more effective as track and trace method for inventory control than as an anti-counterfeit security device. As they relate to the present invention, most or all of these aforementioned array of anti-counterfeit methods and products are covered by numerous US and international patents. However, all of these prior art embodiments of anti-counterfeiting methods and processes have some significant drawback which makes them inferior to, and significantly differentiated, from the present invention.

Further, as it relates to the present invention, these aforementioned drawbacks and differentiations of the prior art are both significant and numerous. For example:

(1) The sheer number of various anti-counterfeit devices in use require numerous and sophisticated testing equipment and considerable awareness and technical skills on their use by the average consumers, in addition to knowing in advance what anti-counterfeit devices are being employed so as to obtain the necessary test equipment and the familiarity with these devices. This knowledge and equipment may be available only to some of the larger institutional buyers with large budgets, while at same time being completely out of the reach of the average and non-expert consumers.

(2) Implemented security methods lose their effectiveness over time as many professional and skillful counterfeiters gain the capability to duplicate them. This leaves the customers with a false sense of security as to the authenticity of their purchased product. For example, while the holograms are touted to be one of the best anti-counterfeit methods, their effectiveness is reduced if an average consumer is not able to differentiate between the genuine hologram tag and a fake hologram tag. Likewise, since many of these aforementioned embodiments require secret codes for verification, they are impractical for the average, non-technical consumer and are thus seriously limited in their overall anti-counterfeit applications. Ironically, for many of the prior art embodiments, such as the use of anti-counterfeit tags, it would not be necessary for the tag to be fully and realistically counterfeited for the counterfeiter to succeed. In actual practice, a superficial appearance or performance of an inexpensive counterfeited tag is enough to fool the average, non-technical buyers.

(3) Since the Internet has become one of the increasing sources for various forms of economic fraud, the aforementioned security methods are not very effective for the average consumer, especially for the products purchased over the Internet from the international sellers overseas, instead of the international manufacturer with near or local distribution presence. Once the buyer receives the product and discovers the counterfeit, it can be very difficult, or nearly impossible, to return the products to the seller for the refund. In addition to the loss of purchase money, the consumer can also lose the integrity of his/her credit card number and personal identity associated with it. While various large governmental purchasing agencies and private institutional buyers such as pharmacies with their high safety standards are more experienced in purchasing from reliable sources, they could at times succumb to erroneous purchasing decision and end up buying counterfeit or tainted items. These items in turn are passed on or incorporated further in the new manufactured products without a thorough validation testing and sold to final customers, with potentially tragic consequences.

(4) Customers who buy products either on the Internet or through catalogs and conventional channels in an effort to further add value through additional manufacturing or assembly, the ones referred to in this embodiment as “consumer-producers”, must have the means to performance test the purchased parts quickly and randomly against the specs, such as mechanical and electronic characteristics.

Normally, such customers have been making purchases from the trusted established sources while relying on the product brand for product reliability and past performances. Now, with the brand and product performances suspect, not every consumer-producer may have appropriate testing equipment or the necessary skills to verify the authenticity of all purchased products, especially the sophisticated computer chips and other solid state components. It is therefore possible to have one critical counterfeit component in otherwise legitimate and reliable product and still have that product fail catastrophically as a result of the unreliability of the counterfeit component. If the component is a counterfeit, then it would not perform according to expected and legitimate specifications from the start. The said consumer-producer may have unknowingly obtained the counterfeit products from the questionable sources and pass these products to its unsuspecting customers.

(5) There are numerous instances where the final consumers are fully aware that the products which they are buying are clearly counterfeit or pirated. In these instances, the customer is actively shopping for a counterfeit product, often at various flea markets, small and inappropriate stores such as gas stations, Internet auctions, fairs, bartering web sites, and web sites streaming pirated professional sports videos across the country, as in the cases of buying pirated or counterfeit DVD movies, computer programs, computer games and music CDs. Normally these products are not health or safety related and are thus easily tolerated by these unethical customers. Such cavalier and dishonest attitude on the part of these final consumers only enriches and further emboldens the producers and vendors of counterfeiter industry and help to defeat those numerous elaborate and expensive anti-counterfeit embodiments, enforcement efforts and methods.

(6) Further, there is a non-universality of these prior art methods and devices. Some of these numerous, intricate and ingenious prior art embodiments of security methods are applicable to some types of products or categories of products and for some consumers, but not to others. No single existing prior art security process or method provides a broad, universal and comprehensive application which is easily implemented and quickly updated across plurality of product categories or market segments with a reasonable simplicity and cost, as does the present invention. The said invention simplifies the anti counterfeit, tainting and piracy battles by turning the power and responsibility over to the joint cooperation and coordination of customer, manufacturer and the ever-increasingly powerful Internet search engine.

Further, in addition to aforementioned product authentication methods, major copyright industry rights holder groups have sought, through numerous international forums, stronger powers to enforce their intellectual property rights across the world, culminating in the proposed new and controversial Anti-Counterfeit Trade Agreement (ACTA) for adoption by European Union, among others. The present invention also compensates for the drawbacks of ACTA.

### SUMMARY OF THE INVENTION

In accordance with the purpose of the present invention as embodied and broadly described herein, the object of present invention is a process and system for product authentication through a continuous, detailed tracking and listing of products, manufacturers, distributors and retailers on the world wide web's vast archival commercial data bases whereby only the bona fide products, product manufacturers, distributors and retailers who are certified authentic are listed.

Further, the present invention includes a provision for blocking or black-listing manufacturers, distributors and retailers of the counterfeit, gray-market diverted, fenced, spelled-alike products, piracy and on-line brand abuses. The enumerated rules governing blocking, black-listing manufacturers, distributors, retailers and the like, including eliminating Internet sites of the same, including a notification of site take-down, are found in subfolders of the Terms of Use tab, as described herein.

Further, the present invention includes a provision for detecting, blocking and eliminating Internet sites which use advertisements of brand name products to attract and infect prospective customers' computers with malware, ransom-ware, spy-ware, scare-ware, rootkits, bootkits or fake anti-virus software or some other type of malicious program or links, for a nefarious purpose, such as personal identity and confidential and proprietary business information theft. These computer infections stem from numerous product advertising sites currently infected with deliberate malicious programs, rogue or fake anti-virus sites and various manipulative redirection chains by their administrators anonymously anywhere in the world which get picked up by various search engines unknowingly and posted on the web, where they are further down-loaded and propagated by unsuspecting consumers, or self-propagated using the consumers' compromised address files.

Should a manufacturer, distributor or retailer engage in counterfeiting or other activities contrary to Terms of Use, SEDS will block the offending sites using current, established methods of industry. To get removed from a “black-list” and reinstated on a “white-list” again, will require a court document which demonstrates that the user has complied with the country's laws, SEDS Terms of Use, plus paid any re-filing fees enumerated in the Terms of Use.

Further, the present invention overcomes disadvantages of the prior art in the protection of plurality of products against piracy, counterfeiting, gray-market diversion, fencing, spelled-alike products, on-line brand abuse and content farming by providing in one quick step and venue an anti-counterfeit process which is simpler and more robust than certain prior art references, for example U.S. patent publication no. 2006/0010503, to Inoue et al., since it greatly simplifies the procedures for product and vendor authentication. Unlike the process described in related and cited prior art applications, the present invention authenticates products without any reliance on, or reference to, the aforementioned tags as in Inoue et al. or randomly generated, or pseudo-randomly-generated, numeric or semi numeric symbolic tokens, such as those referenced in U.S. patent publication no. 2007/0198569, to Johnston, or on the arrays of 2D and 3D bar coding, color coding, numbering, personalization, micro-texting, smart packaging, UV technique involving the introduction of various fluorescing taggants singly or in combination, watermarks, holograms, hard to match colors, random and unpredictable ID and RFID tags, and randomly or pseudo-generated numeric or semi-numeric symbolic tokens as part of its unique authentication process. At the same time, the present invention allows for the continuous use of these aforesaid existing, alternative anti-counterfeit methods, technical standards and devices in those products where they are currently applied as this approach enhances anti-counterfeiting efforts overall.

Further, the present invention can be readily adopted and used with the SEMI Technical Standards and other currently used methods very effectively to produce a robust anti-counterfeit and anti-tainting and piracy shield that is of considerable and significant benefit to the manufacturer, consumer and the general public.

Further, the present invention is universal in scope, by which it is understood to mean that the present embodiment is applicable to a plurality of product categories by having the legitimate manufacturer or the brand name owner supply all the relevant data on its products, producers, distributors and retailers to a reliable, capable, stand-alone robust Search Engine Data Server (SEDS) for an in-depth product and vender authentication and tracking on the Internet, using Web applications. Such product listing is for the purpose of broad authentication that will enable only the legitimate manufacturers, their authorized distributors, dealers and retail outlets, along with their registered products, physical business address, telephone number, fax number and Internet web site/domain name, to be considered authentic, trusted and certified. This process of authentication is novel because it is significantly different from the authentication methods of the prior art and which is detailed for example, in the SEMI T20-1109 and its associated subsidiary standards SEMI T20.1 and SEMI T20.2 which were specifically designed for the semiconductor and related manufacturing industry. For example, one authentication method in SEMI T20 standard involves the potential customer: (1) taking the picture of the Authentication Code on the product with a cell phone camera; (2) sending the said picture to a website which authenticates the code, and (3) receiving the appropriate response to the potential customer to aid in purchasing decision.

The present invention overcomes the drawbacks inherent in the said SEMI T20 standard, which are: (A) Potential customers can not photograph the authentication code which is being offered or advertised on the Internet. Since the Internet sales constitute considerable market segment that is increasing, the inability to photograph and transmit the authentication code, such as QR Barcode, represents a serious drawback for this market. (b) Sophisticated product counterfeiters are known to also fabricate various counterfeit tags that can deceive the cell camera. (C) The need to obtain a free barcode scanning software is certified. (D) An error in transmission and processing of the authentication code picture or text on the authentication website can result in a false-negative error for the potential customer, leading to botched transaction for both consumer and manufacturer.

Further, the present invention with its use of the application of continuous tracking and updating the genuine products from the bona fide manufacturers, and producers through the manufacturers' authorized sales channels, discourages, marginalizes and eventually eliminates questionable, unauthorized and unscrupulous producers, distributors and retailers trading in counterfeit, tainted and pirated products in both the conventional outlets and over the Internet or e-commerce. The said invention also discourages the owners of these unreliable and untrustworthy outlets from feigning ignorance that their products are counterfeited, adulterated, contaminated and misbranded when discovered by independent testing labs and other types of investigation to be in fact.

Further, since the counterfeit products can mimic genuine products in numerous superficial and cosmetic attributes, characteristics and parameters except in overall performance or safety, it is relatively easy for an unscrupulous distributor or retailer to pass off the counterfeit products to an unsuspecting consumer. The process of present embodiment will eliminate such unscrupulous dealers and retailers by allowing the consumer to quickly verify the authenticity of the product, distributor and retailer directly from the original, certified manufacturer data base before making the purchase. Frequently, unscrupulous manufacturers, distributors and retailers go into bankruptcy and reappear under different company name, web site, management and location to continue similar business practice as usual. The present invention will make it extremely difficult for such businesses to remain listed in the search engine or for an authorized retailer to sell counterfeit or pirated products for very long without detection and subsequent de-certification and domain shut down by SEDS or appropriate enforcing authority.

Further, where the products are advertised or sold on various sites, quality and safety-conscious consumers will be able to verify on their computers, personal devices such as “smart phones” for example, if such products, retailers and distributors are certified by the manufacturer simply by querying SEDS. If the aforementioned products or vendors are not listed on or certified by SEDS, such uncertified sites will be ignored by the safety-conscious consumers and over time these uncertified sites will experience the loss of business.

Further, the present invention will encourage bona fide and ethical manufacturers to improve their quality control, manufacturing, inventory accounting and security procedures, especially in the out-sourced, overseas production plants. Since the onus of authentication of distributors and retailers falls completely on the manufacturer, the manufacturer will have greater incentive to plug leakages in its production facilities and to insure that products made by outsourced facilities and their respective sub-contractors and suppliers meet the quality and safety standards for the distribution chain. The manufacturer or brand name owner has also the incentive to increase the confidentiality of the products' manufacturing process by completing for example, the final or critical step of assembly in a different production facility from the one in which earlier phases of manufacturing were done.

Further, the present invention will allow the bona fide manufacturer to detect early signs of product tampering and product diversion from its plants and distribution channels by detecting unusual pattern and discrepancies between the number and type of products delivered to an authorized distributor and retailer and the actual number of the same products sold or returned for refund or registered for warranty purposes. This will make it more difficult for the out-sourced producers to dispose of the surreptitious, out-of-spec, unsafe, excess counterfeit parts since these will not be in Manufacturer's data base and therefore not listed in SEDS.

Further, the present invention is able to act simultaneously as both, a product verification source and as a platform for a trusted master catalog for all listed and certified manufacturers, distributors and retailers. By using SEDs as a giant master catalog of manufacturer-documented and certified products, every distributor and retailer, whether independent, franchised or owned by the manufacturer, will be able to have SEDS do all the administrative paperwork for them, such as: (A) Customer would order products and services from a particular vendor on SEDS web site using the posted individual vendor's product catalog in SEDS. (B) Purchase orders would be passed on through by SEDS to the individual selected vendor who will make the necessary delivery to, or installation of the product or servicing the product, for the customer. (C) Payment from the customer would be made to the vendor's account through SEDS, reducing the customer's risk of exposing credit card number. Customer may still make payment arrangements, other than credit card, with the vendor directly, bypassing SEDS. (D) Product or service warranties would be recorded in SEDS against the vendor's account for verification. If the product sold exceeded the number of products allocated to the vendor, it would raise a flag in SEDS and with the manufacturer. (E) Electronic record of transaction would go to the vendor to execute the order since SEDS does not stock any item for sale, and a copy to SEDS and the manufacturer for their data files. (F) All customer complaints to the vendor, relating to the product or servicing the product, warranties and returned products, would be filed through SEDS with copies going to the affected vendor and its certifying manufacturer and would also serve to eliminate the typical vendor's response to customer's complaint that the given problem is the first time that it happened. Similarly, customer complaints to the product's manufacturer or to the vendor's corporate owners, or to the consumer agencies and governmental bodies could also be made directly, bypassing SEDS. As result of such complaints, it will be for the manufacturer to decide vendor's future listing on SEDS. (G) The certifying manufacturer would have access to the pricing, warranty and servicing information to the extent that it relates only to its products, while SEDS would retain the over-all access. (H) SEDS would be able to disqualify a vendor for violating any business standard set by the manufacturer, mandated by law or any reason clearly specified in SEDS' Terms of Use contract. (I) Certified vendor would be able to advertise itself outside the SEDS that it is listed and certified by SEDS.

Further, the present invention will allow SEDS' administrators to keep the listed manufacturer informed of all inquiries made to SEDS regarding its listed product and requesting information on, and the location of, the closest retailer. If the actual advertised name, address or web site of the queried retailer does not match exactly the authorized name, address or web site recorded in the manufacturer's or SEDS' file, this will flag the retailer and trigger the manufacturer to notify proper customs and anti-counterfeit agencies to investigate or take appropriate confiscation action against the advertising retailer who is not authorized to sell the particular product, or not authorized to sell the said product at a particular location, or who failed to use the registered and approved web site/domain name in its advertising and business transaction as per agreement with the manufacturer and SEDS.

Further, the present invention will allow the listed manufacturers and distributors to keep a current record of potential customers' interest in a given product at any given geographic location, which will greatly aid that manufacturer's marketing strategy.

Further, the present invention will make it much easier for the consumer, especially the institutional or government procurement departments, to purchase reliable and safe products in large quantities from the original manufacturer, or the franchised aftermarket manufacturer or distributor while meeting the required delivery schedules and cost.

Further, unlike the proposed and controversial ACTA, the present invention not only crimps counterfeiting, fraud and piracy that is being conducted through e-trade, but it does so without raising potential concerns for consumers' privacy and civil liberties for innovation and the free flow of information on the Internet's legitimate commerce and for developing countries' ability to choose options that best suit their domestic priorities and level of economic development.

In view of the forgoing, in one exemplary embodiment, the present invention provides a product authentication method or process for a distribution chain. The method includes the step of inputting product information of a plurality of products into an internet accessible first digital database, the product information including identification information of the plurality of products. The method further includes the step of inputting distribution information of the plurality of products into an internet accessible second digital database, the distribution information including locations of the plurality of products along a distribution chain. The method further includes providing a user interface for searching the first and second internet accessible databases and viewing the identification information and distribution information of the plurality of products. The method also includes generating an alarm if a difference exists between the product information or the distribution information inputted into the first and second internet accessible databases and actual product information or distribution information of one of the plurality of products.

In another exemplary embodiment, the present invention provides a product authentication and alarm system. The system includes a first digital database including product information of a plurality of products, the first digital database includes information capable of identifying one or a group of the plurality of products. The system further includes a second digital database including distribution information of the plurality of products, the second digital database indicating locations of the plurality of products along a distribution chain. The system further includes a first user interface communicatively connected to the first and second database, the first user interface being configured to allow a user to search for one or more products of the plurality of products based upon product information, distribution information, or both of the one or more products. The system further includes means for monitoring information submitted through the first user interface, said monitoring means comparing product information and distribution information submitted through queries with product information and distribution information stored in the first and second digital database. The system also includes means for generating and transmitting an alarm to an owner or manufacture of the plurality of products when the product information and distribution information submitted through the user interface differs from product information and distribution information stored in the first and second digital database.

The above-described and other features and advantages of the present invention will be appreciated and understood by those skilled in the art from the following detailed description, drawings, and appended claims.

### BRIEF DESCRIPTION OF THE DRAWINGS

Other objects, features, advantages and details of the present invention appear, by way of example only, in the following detailed description of preferred embodiments of the invention, the detailed description referring to the drawings in which:

FIG. 1A illustrate a schematic view of an exemplary authentication system of the present invention.

FIG. 1B illustrates a schematic view of an exemplary architectural structure of a search engine data server of the present invention.

FIG. 1C illustrates a schematic view of an exemplary product authentication and alarm system according to the present invention.

FIG. 2 illustrates a schematic view of an exemplary product distribution chain and search engine data server of the present invention.

FIG. 3 illustrates an exemplary home page of a search engine data server of the present invention.

FIG. 4A illustrates a partial view of an exemplary sign-in page of a search engine data server of the present invention.

FIG. 4B illustrates a partial view of an exemplary recovering forgotten user ID or password sign-in page of a search engine data server of the present invention.

FIG. 5A illustrates a partial view of an exemplary first registration page of a search engine data server of the present invention.

FIG. 5B illustrates a partial view of an exemplary second registration page of a search engine data server of the present invention.

FIG. 6 illustrates an exemplary customs page of a search engine data server of the present invention.

FIG. 7 illustrates an exemplary distribution and product receipt confirmation page of a search engine data server of the present invention.

FIG. 8 illustrates an exemplary alarm notification or product registration page of a search engine data server of the present invention.

FIG. 9A illustrates an exemplary distribution process according to the teachings of the present invention.

FIG. 9B illustrates an exemplary flow chart of the distribution process shown in FIG. 9A.

### DESCRIPTION OF THE PREFERRED EMBODIMENTS

The present invention provides processes, methods and systems for authenticating products that are purchased or provided for purchase. The features of the present invention provides assurances to manufactures that substantially only authenticated products being sold to consumers through authenticated retailers. Similarly, the features of the present invention further provide assurances to a purchaser that products being purchased have been or can be authenticated. Advantageously, each participating business entity is ensured and can provide suitable marking, e.g. SEDS™, informing consumers that products purchased under SEDS is assured, to a high degree, that the products are genuine. The authentication features of the present invention reduces the number of counterfeit products entering the market, particularly through authenticated product. Further, the features of the present invention provides systems and means for alerting manufactures, or intellectual property owners of products, when a counterfeit product may have entered a product distribution channel.

In one exemplary embodiment, the advancements of the present invention are predicated, in part, on a search engine data server that is accessible by one or more parties along product distribution channel for validating goods, confirming validity of goods or both. The advancement of the present invention are further predicated, in part, on an alarm system and process for warning manufactures, intellectual property owners, or otherwise, that a counterfeit product may have entered the product distribution channel.

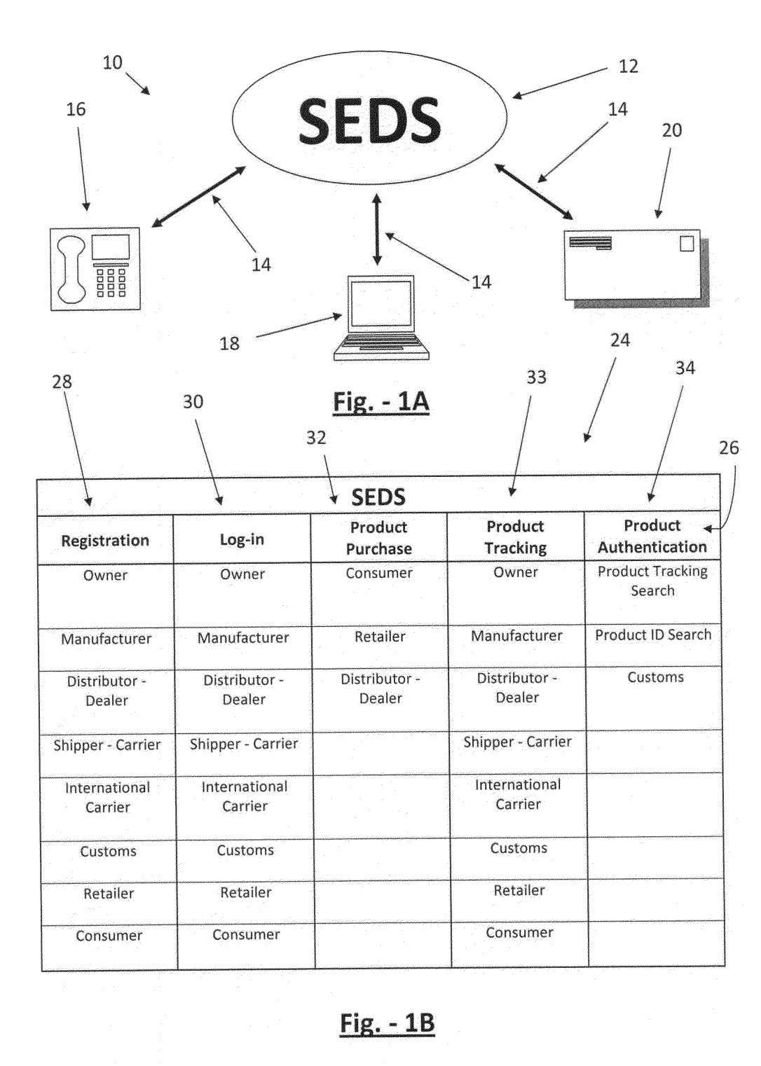

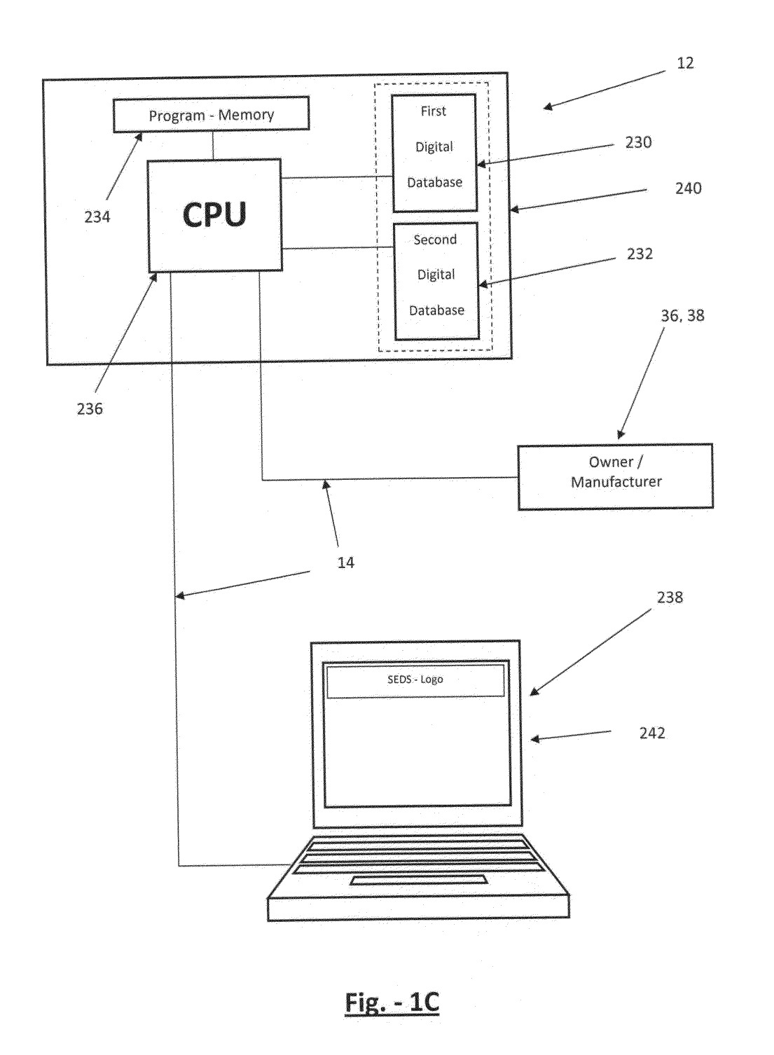

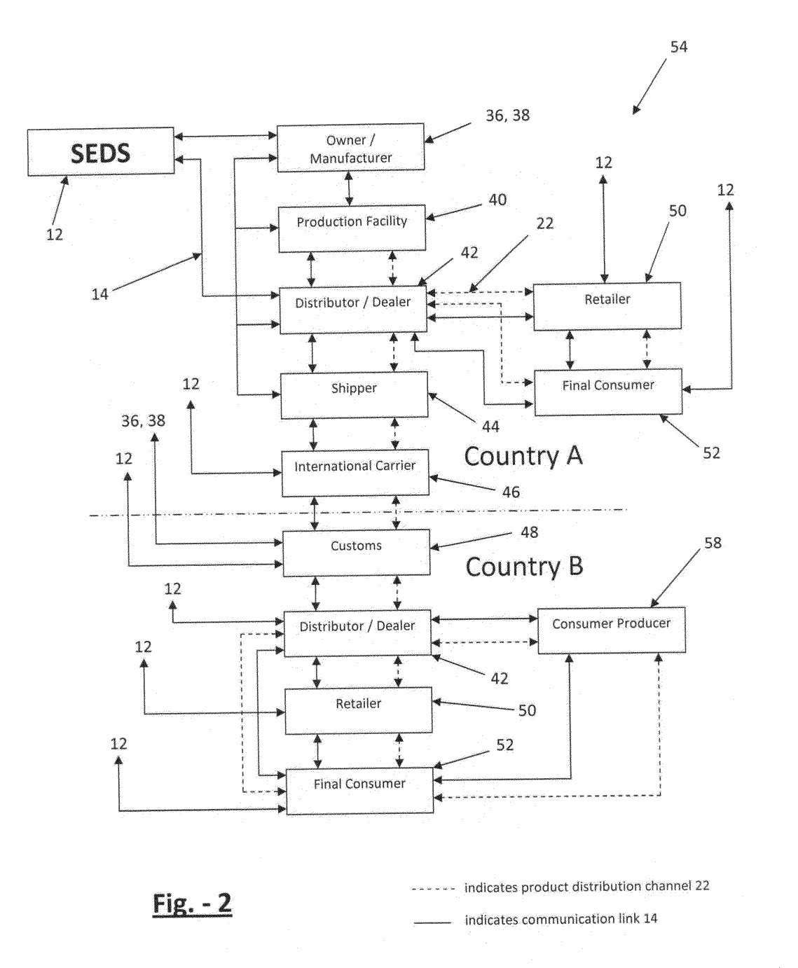

Referring to FIG. 1A, an exemplary embodiment of an authentication system 10 is shown. The system includes a search engine data server (hereinafter referred to as SEDS) 12 that is in communications with one or more users of the system 10, via communication links 14. Search Engine Data Server, with acronym (SEDS) as used in this invention for product, manufacturer and vendor verification and a master general-purpose industrial and commercial product supply catalogue. Exemplary communications links 14 usable with the present invention include wire or wireless communications that are accessible through suitable devices such as telephones 16, computers, tablets, cell phones or the like 18, traditional mail services 20 or otherwise. The SEDS 12 allow various users of the systems to validate or confirm authentication of products traveling a product distribution channel 22.

For example, referring to an exemplary architecture structure 24 of SEDS 12 shown in FIG. 1B, in one exemplary embodiment, various components 26 of the SEDS 12 are shown in a row, which are accessible and/or usable by various parities of a product distribution channel 22, such as through user interfaces. It should be noted that multiple SEDS 12 may be used, each having a particular product distribution channel or channels 22, or a single SEDS may be used having multiple sets of components 26 which are each configured for a particular product distribution channel. Each component may comprise one or more electronic page(s) for viewing, entering product information or both. A non-exhausted listed of components 26 includes registration page(s) 28, log-in page(s) 30, product purchase page(s) 32, product tracking page(s) 33 and product authentication pages(s) 34. It should be appreciated that other pages exist as shown and described herein. As previously mentioned, it is contemplated that these components, or pages, 26 are accessible through various communications links 14, devices and methods (e.g. telephone 16, computers systems 18, mail services 20 or otherwise).

Referring to FIG. 1C, an exemplary SEDS system 12 is shown. The system is configured to authenticate products traveling along a distribution chain. In this configuration, the SEDS system 12 is shown in communication with an owner 36 and/or manufacturer 38 for inputting product information and distribution information of one or more, or plurality, of products. Though other configurations can be arranged, the product information is stored in a first digital database 230, which may comprises a digital memory device, and the distribution information is stored in a second digital database 232, which may also comprise a digital memory device. The first digital database 230 and the second digital database 232 are stored or associated with a computer 240 having a central processing unit 236 and program memory 234, which stores instructions for generating screen windows or other pages, as shown in FIGS. 3 through 8. The computer 240 is in communications with users of the system, e.g. owners 36, manufacturers 38, production facilities 40, distributors or dealers 42, shippers or carriers 44, international carriers 46, customs 48, retailers 50, consumers 52 or otherwise, via communication links 14, which utilize the user interfaces shown in FIGS. 3 through 8, or otherwise, to review, search, record information or otherwise as discussed herein.

Advantageously, the program stored on the program memory 234 provides instructions for generating user interfaces 238 on nearby or remotely located computer screens 242. The programming also includes suitable instructions for allowing users to input or review information disposed on the first digital database 230 or second digital database 232. Further, in one highly preferred embodiment, the programming includes instructions for monitoring search queries submitted by user and comparing such search queries with stored information on the first and/or second digital databases 230, 232. Should differences exists between search queries and recorded product information and distribution an alarm is generated, via the instructions disposed on the program memory, which is transmitted to the owner 36 or manufacturer 38 indicating possible counterfeit or unauthorized transactions or products within the distribution chain. Such alarms may comprise e-mails, phone calls, mail correspondence or otherwise, which may be automated. It should be appreciated that the programming on the program memory includes suitable instructions for achieving the functions of the web pages, or the user interface, shown in FIGS. 3 through 8 and as described herein.

With respect to product information stored in the first digital database 230, it is contemplated that information is suitable for distinguishing one product from another product. Contemplated product information that may be stored and searched on the first digital database 230 includes: product or supplier trademarks, bar code numbers, lot numbers, specific unique product ID numbers, or otherwise as described herein. Contemplated distribution information that may be stored and searched on the second digital database 232 includes: total production number, number of products distributed to each link of the distribution chain, e.g. distributor or dealer, shipper or carrier, retailers or otherwise, or otherwise as described herein.

Depending upon the particular configuration of SEDS 12, various users of the system 10, are or may be authorized to view and/or enter tracking data. While one configuration is particularly shown in FIG. 1A, examples of envisioned users include owners of intellectual property rights of products 36, manufacturer 38 of products, distributor or dealer 42 of products, shipper or carrier 44 of products, international carrier of products 46, customs 48 where products pass through, retailers 50 of products and consumer 52 of products. It should be appreciated that any one of these users, combinations of these users, all users or otherwise, may be granted viewing permission, tracking permission, purchasing permission or otherwise as shown or described herein.

By various latitudes manufacturers, distributors and retailers are granted viewing permission under enumerated sub-folders of Terms of Use tab 190. The owner/manufacturer 36, 38 has the widest latitude since it can view and track products to and from all distributors 42, and retailers 50 handling its products. Also, all products from production facilities 40, to respective distributors and retailers via shippers 44, and international carriers 46. Distributors 42 can view and track products to and from all retailers 50 receiving its products. Retailers 50 can view and track products only to and from retailers under the same ownership or management. They can also track the status of scheduled orders from distributors. Customs 48 can view and track everything which owner/manufacturer 36, 38 can view and track, in its respective country under the enumerated sub-folders of Official Use tab 300. Consumers 52 can view for verification: name of certified manufacturer, distributor, retailer, products and countries under tabs 154, 162, 166, 170, 172, 176 and 180.

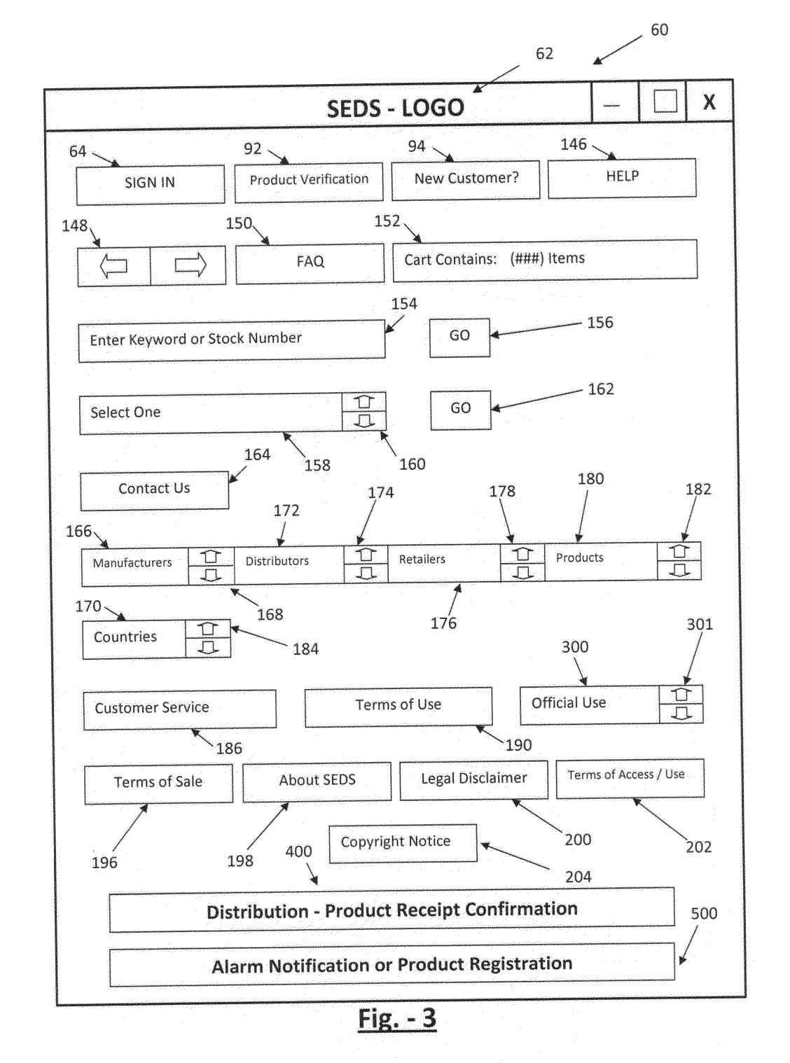

Referring to FIG. 2, an exemplary SEDS 12 distribution and communication chain 54 is shown for tracking and authenticating one or more products. In this configuration, a single-line view of a greatly simplified distribution channel for product and data flow from the owner or manufacture 36, 38, to the final consumer 52 located in a same or a different country, e.g. Country A, Country B, or otherwise, is shown. As shown, exemplary product distribution channels 22 and communications links 14 provide distribution of the products and interaction between the various users of the system 10. As previously mentioned, it should be appreciated that the communication links 14 may utilize communication links shown in FIG. 1A including telephones 16, computers or the like 18, mail services 20 or otherwise. However, in one preferred configuration communications between users of the system 10 and SEDS 12 is achieved through computers and the internet.

The manufacturer's 38 main office and production facilities 40 can be located anywhere in the world, but is illustrated in Country A. Some ancillary items such as warehouses, for example, are omitted for simplification. The manufacturer 38 could also be a licensee of the intellectual property rights owner 36, e.g. trademark, brand-name or otherwise. It is contemplated that in one exemplary embodiment the manufacturer 38 is solely responsible for certifying and authorizing its users, e.g. distributors or dealers 42 and retailers 50, to sell its brand name products. Further, the manufacturer would also be solely responsible for enumerating a particular price range and warranty, which may be done at a particular physical address location and on a particular web site or sites. Still further, the manufacturer is also solely responsible for listing and certifying its distributors or dealers 42 and retailers 50 on SEDS 12. It is contemplated that unless certified by the manufacturer 38, distributors 42 and retailers 50 would not be listed in SEDS as certified vendors.

As discussed in greater detail herein, in one configuration, before, during or after a transaction, the distribution chain information, i.e. the particular distributor 42, shipper 44, retailers 50 or otherwise, provided by the manufacturer 38, can be compared to ensure that the product is authentic. During this comparison, if there is any discrepancy between the information on file with SEDS and information actually provided to the consumer, such as distributor 42, retailer 50 or otherwise, an alarm is or can be generated through SEDS 12, which will alert the manufacturer 38 or owner 36, via communication link 14, to undertake appropriate action against the non-authorized vendor of its products.

In greater detail, still referring to the SEDS distribution and communication chain 54 shown in FIG. 2, the users of the system 10 are shown connected through dashed lines representing the product distribution channel 22. The product distribution channel 22 may comprise any suitable means for movement of products from the production facility 40 to the consumer 52 including, without limitation, distribution by persons, vehicles combinations thereof or otherwise. The distribution and communication chain 54 further includes communication link 14, which is represented in solid lines, for communication between users of the system 10. The communication channel may utilize any suitable communication link 14, such as telephone 16, computer 18 and mail service 20. The communication link 14 may be configured for voice communication, digital communication, physical communications or combinations thereof.

The manufacturers production facility or facilities 40 may be owned and controlled by the owner 36 or manufacturer 38 of the product, or an independent subcontracting production facility, either domestic or out-sourced in a different country. All the production data will be directed to the owner 36 or manufacturer 38 for posting to SEDS 12. It is believed that independent subcontracting production facilities, more so than the manufacturer-owned and controlled production facility 40, are the source of the majority of counterfeit or pirated versions of authentic products. As such, these independent subcontracting production facilities require greater supervision than owner or manufacturer owned or controlled production facility 40 for SEDS to function optimally. The typical production and marketing data, passing through communication link 14, are entered into SEDS 12 by the owner or manufacture 36, 38 and consists of established standard product information, including product identification (which may be specific for each product or product type), volume of production or transfer, warranty, pricing and product registration cards and vendor data, which is generally available in both the printed and virtual catalogs. Advantageously, the use of registration cards, for the purpose of warranting the product or otherwise, serves as a check on the retailer 50 and insures that the retailer does not comingle his inventory of bona fide/authenticated products with counterfeit products that have been obtained from questionable sources. It should be appreciated that some items in the distribution and communication chain 54, such as warehouses, are omitted for simplification.

The distributor or dealer 42, in Country A, B or otherwise, may also be under the control of owner 36 or manufacturer 38, or an independent. As with independent production facilities, these independent distributors and dealers present another weak link in the distribution chain since they may stock both the bona fide products, counterfeit and pirated products, commonly referred to as “double-dealing”. Thus, while a distributor can be certified as a “trusted source” for a manufacturer A, he may not be certified for other manufacturers whose products he also carries. Some of these products could be the counterfeit versions of manufacturer 38 products.

However, such “double-dealing” distributor or dealer 42 risks decertification, black-listing, domain shut down and confiscatory raid by the proper law enforcement authorities should SEDS detect and the owner 36 or manufacturer 38 notify them that said distributor is trafficking in counterfeit products. The consequences of being detected conducting illegal business transactions will be a sufficient incentive for the distributor or dealer 42 not to comingle counterfeit products with bona fide ones. To remove any possibility for the distributor or dealer 42 to double-deal or to co-mingle his product line, dealers of a certified manufacturer would not be allowed by SEDS' Terms of Service contract to advertise, post or distribute products from the manufacturers who are not certified by SEDS. Should a dealer violate the SED's Terms of Service contract in regards to manufacturer 38, the dealer could be “black-listed” from SED'S entirely, even if not in any violation of said contract in relation to other manufacturers whose products are certified.

The retailer 50 for the distributors or dealers 42, in Country A, B or otherwise, may also be under control of owner 36 or manufacturer 38, or independent. As such, independent retailer presents yet another weak link in the distribution chain since it may stock both the bona fide products, counterfeit and pirated products, referred to in this embodiment as “double-dealing”. Thus, while a retailer 50 can be certified as a trusted source for an owner 36 or manufacture 38, he may or may not be certified for other manufacturers whose products he also carries. Some of these products could be the counterfeit versions of owner 36 or manufacture 38 products. Should a retailer violate the SED's Terms of Service contract in regards to owner 36 or manufacture 38, the retailer could be “black-listed” from SED'S entirely, even if not in any violation of said contract in relation to other manufacturers whose products are certified. As with distributors and dealers 42, the consequences of being detected conducting illegal business transactions will be a sufficient incentive for the retailer 50 not to comingle counterfeit products with bona fide ones. To remove any possibility for the retailer 50 to “double-deal” or to co-mingle his product line, retailer of a certified manufacturer would not be allowed by SEDS' Terms of Service contract to advertise, post or distribute products from the manufacturers and dealers who are not certified by SEDS. The integrity of SEDS demand that the product and everyone handling the product along the distribution chain be certified as a genuine trusted source.

With continued reference to FIG. 2, the final consumer 52 in Country A purchases from SEDS 12 certified and trusted retailer 50. Under the retailer 50 are two special classes of retailers: (A) Factory outlets and (B) Liquidators. The liquidators, who are the more complicated case of the two, go by various names such as inventory liquidators, merchandise liquidators, wholesale, closeouts and surplus liquidators. Specializing by industry, these retailers obtain products from numerous sources, such as manufacturers, distributors, other retailers and the general public, who are unloading their products or property due to going out of business; or experience some economic hardship such as bankruptcy; or due to fire sale; or experiencing customs or tax seizures. Both are treated by SEDS the same as any other distributor or retailer. Every product must be tracked back to the bona fide manufacturer of brand name owner. The liquidators and factory outlets who cannot document their products are simply not listed or certified by SEDS.

However, it is also possible that the final consumer 52 purchases product through the internet or otherwise, from a distributor or dealer 42, from a production facility 40, from owner 36 or manufacture 38, or even through SEDS 12. It is still further possible that the final consumer 52 purchases owner 36 or manufacture 38 product from a consumer producer 58 in another country, such as Country B. The shipper 44 in Country A transports produced goods from the production facility 40 to another chain of the distribution and communication chain 54, including to an international carrier 46 configured for international shipment of the product. It is envisioned that the shipper 44, as with other users, enters product information into SEDS for tracking. The international carrier or transporter 46 transports produced goods from Country A to Country B. As with shipper 44, it is envisioned that the international carrier 46 enters product information into SEDS for tracking.

As product is transported across country boarders, it is envisioned that local custom departments 48 inspect, certify and enter product information into SEDS 12. This is discussed in greater detail, herein, and in particular with reference to FIG. 6. Once the product is approved by local customs 48, the products are shipped or otherwise received by a distributor or dealer 42 of Country B, which may be under the control of owner 36, manufacturer 38, or independent. In one exemplary embodiment, SEDS 12 treats dealer 42 of both Country A and B the same. Retailer 50 of Country B receives the product from the distributor or dealer 42. As with the distributor or dealer 42, the retailer 50 may be independent and become another weak link in the product distribution chain since it may stock and retail bona fide products alongside with counterfeit and pirated ones, knowingly or unknowingly. Thus, while a retailer 50 of Country B can be certified as trusted source for owner 36, manufacturer 38, he may or may not be certified for other manufacturers and dealers whose products he also carries. Some of these products could be the counterfeit products of owner 36, manufacturer 38. However, such double-dealing retailer risks decertification, black-listing, domain shut down and confiscatory raid by the proper law enforcement authorities should SEDS 12 detect and the owner 36, manufacturer 38 notify them that said retailer 50 is trafficking in counterfeit products. The consequences of being detected conducting illegal business transactions will be a sufficiently unfavorable for the retailer 50 so as not to comingle counterfeit products with bona fide ones. To remove any incentive for the said retailer to “double-deal” or to co-mingle his product line, retailers 50 of a certified manufacturer 38 would not be allowed to advertise, post or distribute products from manufacturers or distributors who are not certified by SEDS 12. Should a retailer violate the SED's Terms of Service contract in regards to manufacturer 38, the retailer could be “black-listed” from SED'S entirely, even if not in any violation of said contract in relation to other manufacturers whose products are certified.

The final consumers 52 of Country B purchase products from retailer 50, distributor or dealer 42 and consumer-producer 58, any of which may reside in either Country A or B.

As previously mentioned SEDS 12 provides an accessible database of information pertaining to products. Accordingly, it is contemplated that SEDS 12 includes a computer, servers or series of computers and servers, configured for entry and storage of product data, as well as information pertaining to a distribution chain. Further, it is contemplated that SEDS may be configured for a single product, plurality of products for a particular business or industry, or even all encompassing system for tracking numerous product along various industries. Accordingly, it is expected that the SEDS electronic components would be suitable in size and processing power to satisfy thousands, if not millions, of users. Further, SEDS is further configured to provide a user interface, as described herein or otherwise, to allow users of SEDS to access information pertaining to product purchased or products that may be purchased. The current refinements in algorithms for the search engines and the continuous reduction in cost of computer memory, makes SEDS 12 and the authentication system 10 of the present invention ideally suited to fight product counterfeiting and other forms of intellectual property thefts through the effective product tracking across international borders in real-time.

In exemplary embodiments, SEDS 12 has the following minimum attributes:

SEDS can be accessed by customers and officials for e-commerce and product verification and authentication through a web browser anywhere in the world.

SEDS can be physically located anywhere in the world and is a trusted authentication source on which consumers anywhere in the world can rely on. Since it is SEDS' Administrator's responsibility to ensure that the manufacturer is bona fide, it should be expected that manufacturer's application for the privilege of being listed on SEDS will be thoroughly investigated. Once decertified by SEDS, manufacturers, distributors and retailers should have extreme difficulty in being re-certified.

The owners or Administrators of SEDS provide a proprietary catalog inventory listings and product tracking, listing and interactive software for all registered and licensed manufacturers, distributors and retailers, both domestic and international. This latest state of the art software is sufficiently resistant against variety of hacking and virus attacks that are designed to crash the entire system.

SEDS would list and alert the manufacturer regarding phishing and malware sites posing as genuine retailers of bona fide distributors which somehow slipped past the manufacturer's scrutiny or became infected inadvertently, when such sites are reported by consumers and employees of bona fide manufacturers, distributors and retailers.

SEDS being a trusted and certified source, provides incentive for various purchasing departments in both private and public sectors to adopt its listings of products, manufacturers, distributors and retailers as a form of “Certification of Quality” and require by corporate policy, ordinance or statute that all business dealings with a particular manufacturer, distributor and retailer be conducted only if the said manufacturer, distributor or retailer is certified and listed in SEDS. This will provide SEDS with a business advantage over other listing sites to the extent that the manufacturers, distributors and retailers will gravitate towards SEDS' standards for listing and thus become reluctant to engage in any illicit transaction which could get them black-listed by SEDS. Over time, uncertified sites will be marginalized ensuring that consumers and general public are receiving bona fide and safe products.

SEDS will provide, as part of its comprehensive service, a new, safe and virus-free web site for all its registered and licensed manufacturers, distributors and retailers to ensure that the site does not harbor malicious programs that could infect the customers' computers or legitimate-looking programs designed for fleecing the consumers. In those cases in which the registered and licensed manufacturers, distributors and retailers wish to retain their current sites, absent the ability to order products from the said sites, SEDS would also verify that the sites are not already infected with viruses. At regular intervals, SEDS would remotely inspect all these independently-listed sites for signs of viruses and disinfect them. If the site is made intentionally malicious by its owners or administrators, SEDS would shut it down immediately. Consumer users should be confident that their computers will not become infected by malware downloads from any certified manufacturer, distributor or retailer. In addition, SEDS will require that all certified products advertised on Internet be advertised only on SEDS and only by certified vendors.

Since SEDS has invested a great deal of capital and good will in providing reliable and authentic product information, it will reserve the right to decertify any manufacturer who is not moving aggressively against any vendor when presented with evidence from SEDS and other reliable sources that such vendor is dealing in counterfeit, tainted, pirated, spelled-alike, gray-market, fenced products, on-line brand abuse and content farming. SEDS will list all known sites currently hosting illegitimate or criminal activities.

SEDS are owned or administered by: (1) national government entity responsible for manufacturing and commercial interests; or (2) international entity responsible for manufacturing and commercial interests; or, (3) private entity dedicated to protection and promotion of manufacturing interests world-wide; or, (4) existing search engine entity which expands its business scope to encompass new enterprise as described by this invention; or, (5) some combination of the above indicated methods or some additional new ones.

SEDS owner or Administrator should be of high ethical and business reliability due to the highly proprietary, confidential, legal and critical business data bases being administered.

All static advertisements on SEDS should be from the listed and trusted manufacturers and be appropriate or relevant for the product being queried and not distract from the primary subject of listing. No pop-up ads should be allowed. The main sources of revenue to SEDS owners should be from listing, certification fees and percentage of e-commerce sales.

While SEDS acts as one giant, super catalog, it does not stock or deliver any product. All transactions and orders are directed to the selected certified Manufacturer, Distributor or Retailer according to user's or customer's selection.

Further, the SEDS Administrators, as indicated above, will be the primary source to investigate and qualify the potential manufacturers and establish basic guidelines for listing only the bona fide manufacturers in its data base, in a process referred herein as “white-listing”. Also, to establish parameters for keeping known counterfeit manufacturers, distributor and retailers off the data base, in a process referred herein as “black-listing”. The responsibility for investigating and qualifying distributors and retailers falls to the certified manufacturer.

Further, no distributor and retailer can have its domain or sub domain registered to anonymous address. All owners must be fully registered per individual country's laws, and all trades must be conducted in a transparent, traceable electronic transactions. This qualifying process will limit counterfeit and pirate sites. Should an authorized site on SEDS engage in counterfeit sales or piracy, contrary to the Terms of Service, such site will be blocked immediately with proper take down notice displayed and the Customs officers raid the business establishment and confiscate the counterfeit and pirated merchandise, if any. Likewise, the owners or administrators of SEDS should establish the appeal process and the criterion for moving the manufacturers, distributors and retailers from a less favorable list to the more favorable one.

Further, SEDS assigns, in a process of “white listing”, every certified and bona fide manufacturer 38, distributor 42 and retailer 50 an user id, profile, alpha-numeric password, domain and sub-domain, per its Terms of Use. The user will have some discretion as to the names of web sites. The certified manufacturer provides the SEDS with list of its certified distributors and retailers. Initially, SEDS certifies the manufacturer and assigns it in similar process an user id, profile, alpha-numeric password, domain and sub-domain, per its Terms of Use.

Further, by various latitudes manufacturers, distributors and retailers are granted viewing permission under enumerated sub-folders of Terms of Use tab 190. The owner/manufacturer 36, 38 has the widest latitude since it can view and track products to and from all distributors 42, and retailers 50 handling its products. Also, all products from production facilities 40, to respective distributors and retailers via shippers 44, and international carriers 46. Distributors 42 can view and track products to and from all retailers 50 receiving its products. Retailers 50 can view and track products only to and from retailers under the same ownership or management. They can also track the status of scheduled orders from distributors. Customs 48 can view and track everything which owner/manufacturer 36, 38 can view and track, in its respective country under the enumerated sub-folders of Official Use tab 300. Consumers 52 can view for verification: name of certified manufacturer, distributor, retailer, products and countries under tabs 154, 162, 166, 170, 172, 176 and 180.

Further, SEDS should ensure that: (A) No site which was blocked or taken down in government take down seizure, returns or continues operating by redirecting customers to its assigned website's alternative or “doppelganger” domain name using seizure workaround software. (B) The listing of bona fide products, distributors and retailers is current. This is done by constant querying the bona fide manufacturer for the current status of their products, distributors and retailers. (C) Its clients of manufacturers are fully alerted whenever the fraudulent data is being entered, distributed or reported by consumers, officials, other distributors, retailers and manufacturers. Also, SEDS will monitor subdomains if they mimic actual certified domains. (D) SEDS verification system is a robust system, capable of weathering vigorous Denial of Service attacks from the worlds hackers while ensuring that the current data residing in its numerous redundant data servers is not corrupted or destroyed by accident or internal sabotage. (E) Its programs for consumers are based on the best methods and practices of web-site design and are user-friendly to the extent that the consumers' query for an advertised product is easy and self-evident or obvious.

In view of the foregoing, in one exemplary embodiment, referring to FIG. 3, a home or first web page 60 of SEDS's sites where the SEDS's verification functions are listed both independently and where they are incorporated into a general purpose commercial and industrial supply and service catalog. Since SEDS can easily serve as an extensive commercial and industrial catalog in addition to the primary function as a product verification source, the home page 60 contains numerous boxes and links for both the product verification and business transactions. SEDS Administrator also determines if and how the home page 60 is modifiable by the user.

Since SEDS 12 is also a giant, virtual, general, all-purpose certified product catalog, its home page 60, as well as other pages, are arranged in such a fashion to list both authenticated listed products, distributors, retailers and to facilitate the conduct of e-commerce business transactions for the same. Depending on the discretion of SEDS' owner or administrator, the home page 60 with related links can be designed as a standard model to serve all the manufacturers, distributors and retailers with a common format or only the sizeable majority. The remaining manufacturers, distributors and retailers can design their own proprietary virtual Internet catalog home page 60 with related links, consistent with SEDS' criteria. For this reason, the search functionality is installed up front. For the purpose of simplicity, the discussion regarding SEDS' enormous potential for virtual industrial or commercial catalog functions will be limited here to only those Internet catalog functions most relevant to the present invention, while other less relevant functions are only mentioned informatively and without elaboration.

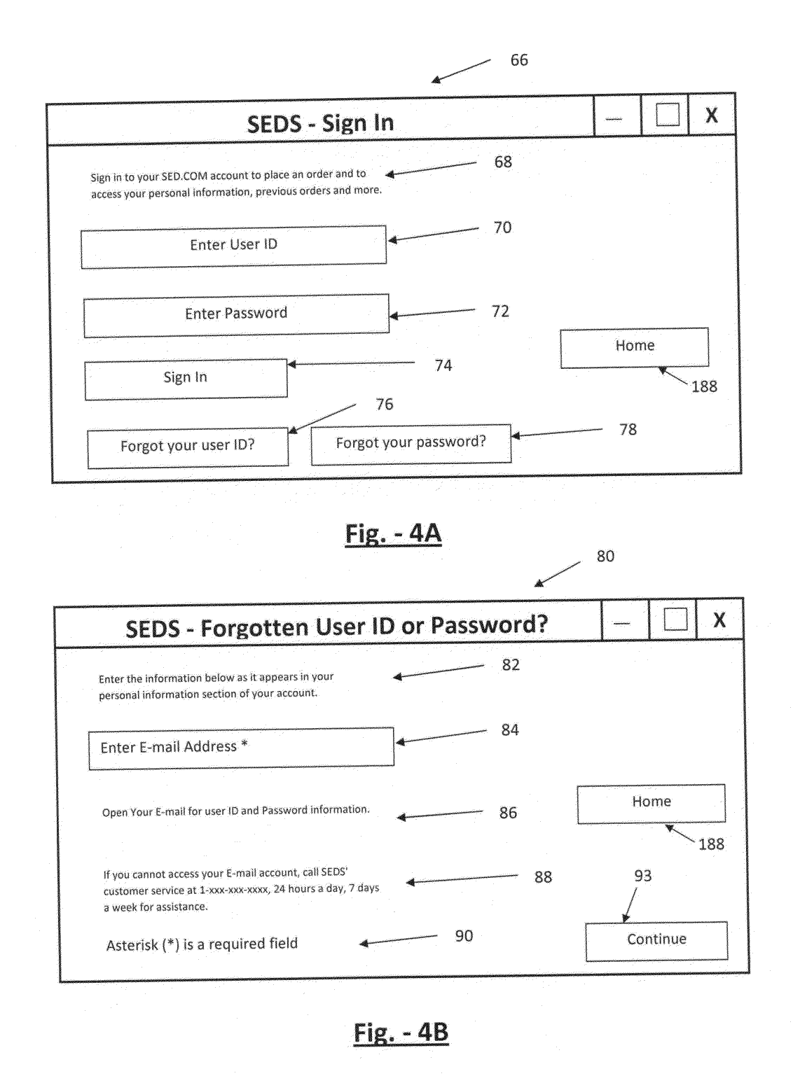

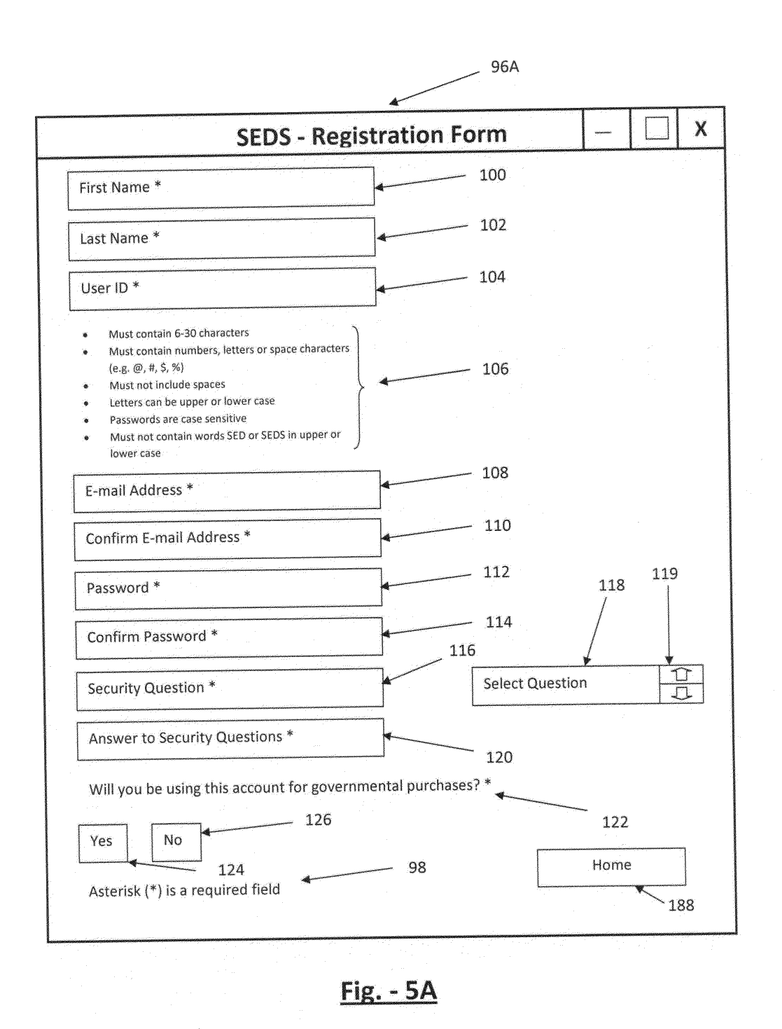

Referring again to the exemplary embodiment shown in FIG. 3, the home page 60 includes a logo 62, which appears at the top of the page, and potentially every other page as well. As with many internet browsers, the home page 60 includes typical features such as minimize, full page and close icons. The home page 60 further includes a sign-in tab 64 for operating SEDS 12 as a registered user and to let the user customer access his/her SEDS account. FIGS. 4A and 4B provide further detail for signing in as a registered user. However, in at least one exemplary embodiment, it is not a requirement for the user to sign-in in order to simply use of SEDS for verification and authentication of the product, manufacturer, distributor, retailer or to just examine SEDS' master product catalogs. By hovering over the sign-in tab 64, text prompts “Sign in to your SEDS.com account to place an order and to access your personal information, previous orders and much more”. This text prompt, or instruction 66, is also shown in FIG. 4A.

By clicking on the SIGN IN tab 64, the user is transferred to a sign-in web page 66, see FIG. 4A, wherein, after filling the required user ID 70 and password 72, the user clicks on the sign-in tab 74 to execute the command. By signing in the user is permitted to engage in e-commerce, after which he is automatically transferred back to the home page 60 shown in FIG. 3, for further queries. Should the user forgot his/her ID or password, they are provided the opportunity to click on the “forgot your user id” tab 76 or “forgot your password” tab 78, wherein thereafter the user is transferred to the forgotten user ID or password webpage 80, see FIG. 4B. The forgotten user ID or password webpage 80, shown in FIG. 4B, includes instructions 82 to enter your e-mail into e-mail box 84. The webpage 80 further includes instructions 86 to open your e-mail for your user ID and password information and instructions 88 “If you cannot access your E-mail account, call SEDS' customer service at 1-xxx-xxx-xxxx, 24 hours a day, 7 days a week for assistance.” Also, the webpage 80 includes further instructions 90 indicating ‘Asterisk (*) is a required field”. Upon completion, the user clicks on the continue tab 93 and is directed to the home page 60, shown in FIG. 3. Alternatively, at any time a user can return to home page 60 by clicking home tab 188.

Referring again to FIG. 3, the home page 60 further includes a product verification tab 92 which allows the user to bypass the sign-in requirement. The product verification tab 92 also records all inquires made regarding the product by the user through cookies. This information is passed by SEDS to the owner 36 or manufacturer 38. Upon clicking on the product verification tab 92, the user is free to surf other boxes and tabs within the home webpage 60 but is not allowed to conduct e-commerce in SEDS, which requires registration.

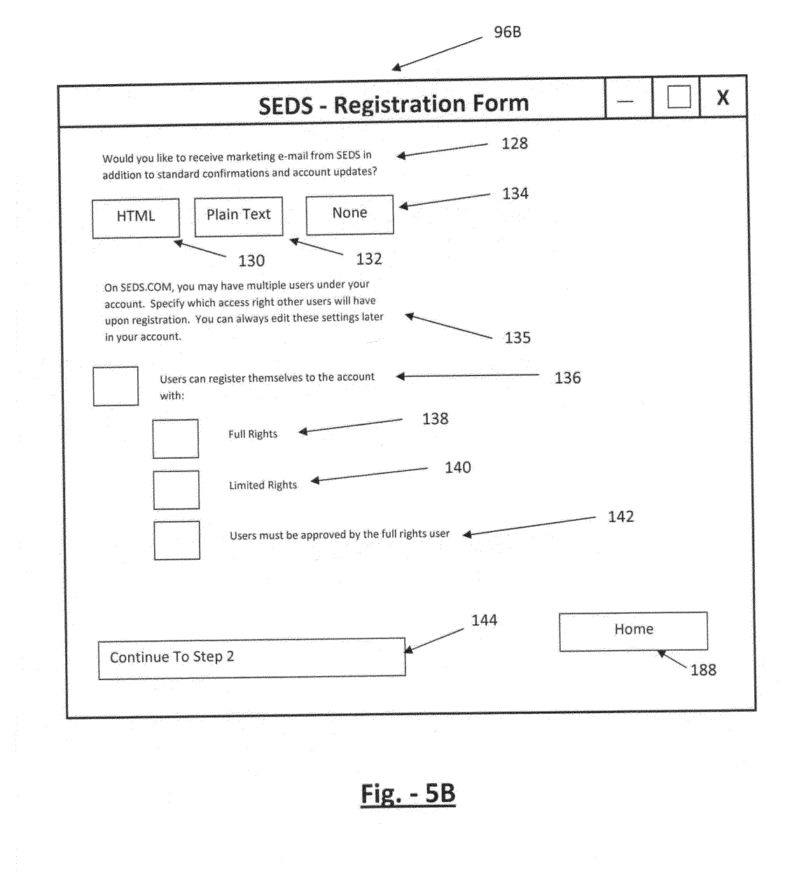

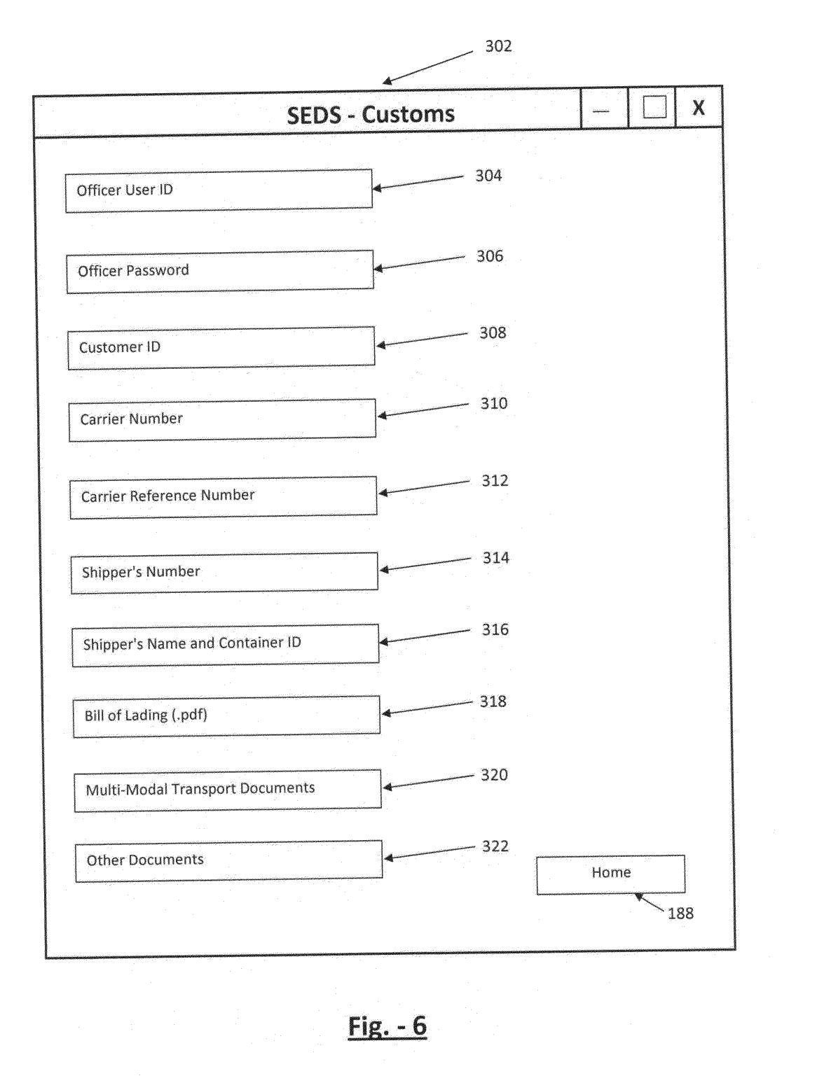

The home page 60 further provides a new customer tab 94, which directs the user to SED'S registration form 96A, shown in FIGS. 5A and 5B. This box is used when the consumer elects to conduct transactions through the SEDS' virtual e-commerce catalog. The registration form 96A includes instructions 98 indicating that “Asterisk (*) is a required filed”. The registration form 96A requires entry of information in the first name box 100, last name box 102, and user ID box 104. The registration form further provides instructions 106 on suitable or required characters to be used in selecting a user ID. Specifically, the instructions 106 requires that: the user ID must contain 6-30 characters; may contain numbers; letters or space characters, such as $#@%, must not include spaces; letters can be upper or lower case; passwords are case sensitive; and must not contain words SED or SEDS in either upper or lower case.

The registration form 96A further includes an e-mail address box 108, confirm e-mail address box 110, password box 112, confirm password box 114, security question box 116, or pre-selected security question box 118 with scroll bar 119, answer to security question box 120 and a questions 122 whether the user will be using the account for governmental purchases and further provides answer boxes yes 124 and no 126.

In the continuation registration form 96B, shown in FIG. 5B, the form further includes instructions 128 on whether the user would like to receive marketing e-mail from SEDS in addition to standard confirmations and account updates. The registration form 96B further includes boxes for selecting e-mail setting, e.g. HTML 130, plain text 132 or none 134. The registration form 96B further includes instructions 135 and corresponding account box 136 on whether the user wishes to have multiple users under the account and to specify which access right other users will have upon registration including: users can register themselves to the account 136, full rights 138 limited rights 140 and users must be approved by the full rights user 142. The registration form 96B further provides a continue to step 2 box 144, which may request additional information. Such additional information could consist of credit card numbers, banking information or otherwise. At any time a user can return to home page 60 by clicking home tab 188.

Referring again to the home page 60 shown in FIG. 3, the home page further includes a help tab 146 to assists the user in managing all his/her service requests and support calls. By clicking the help tab 146 a new window is provided for selecting help on particular matters or submitting particular queries. The help tab 146 assign these requests and calls to different resources of SEDS according to priority, problem type and technical skills. This helps SEDS and its clients resolve problems faster such as: (a) forgetting one's user ID/changing user ID; (b) forgetting one's password/changing a password; (c) requiring a product support; (d) needing additional FAQ. In addition, the help tab 146 expedites workflows by improving communication and efficiency in regards to client and internal technical support.

The home page 60 further includes forward and back arrows 148 for traversing through different web pages of SEDS 12. These buttons may appear on every page. The home page 60 further includes a frequently asked questions (EA.( ) tab 150 comprising, in part, of the following drop-down menus: a) Signing in; b) Updating My Account; c) Ordering; d) Order Status; e) Verification Process; f) Product Information; g) Registering; h) General Information; i) Technical Questions. Clicking on any one folder, drills down into sub-folders and sub-sub-folders. The home page 60 further includes an numerical indication 152 of items that have been selected for purchase. The quantity is constantly and automatically updated with every product purchased and is editable before the close of transaction.

The home page 60 further includes keyword or stock number box 154 for searching for a desired product for purchase or verification. By entering information into the keyword or stock number box 154 pertaining to the product, and clicking go tab 156, a user is allowed to search for or is provided the following items:

A. Name of the Manufacturer. If certified and listed by SEDS, the name of the entered Manufacturer will appear with all the pertinent information, such as: (1) Headquarters address, relevant phone, FAX numbers, e-mail address and web site; (2) Links to its products; (3) Links to countries in which it is doing business; (4) Links to authorized distributors, retailers, their physical addresses, phone, FAX numbers and e-mail addresses; (5) Links to web sites on which each distributor and retailer is authorized to conduct e-commerce over Internet; (6) Helpful suggestions to assist the user in making a safe selection and purchase.

B. Name of the product brand from the purported manufacturer. If the brand is bona fide and listed in SEDS, the following will appear with all the pertinent information, such as: (1) The manufacturers headquarters address, relevant phone, FAX numbers, e-mail address; (2) Links to all its products; (3) Links to countries in which the indicated product brand is authorized to be sold; (4) Links to authorized distributors, retailers, their physical addresses, phone, FAX numbers and e-mail addresses, carrying the indicated product brand; (5) Links to web sites on which each distributor and retailer is authorized to do business; (6) Helpful suggestions to assist the user in making a safe selection and purchase. If any of the first five SEDS-supplied items of information above in A and B do not agree with the actual situation with the vendor offering the product, it is an indication that the particular advertised product is: (1) counterfeit; or (2) the particular vendor is not authorized by the manufacturer to sell the given product at the particular location; or (3) that the particular vendor is not certified by the manufacturer whose product is being offered for sale. This information will be relayed by SEDS to the user through a text displayed on monitor.

C. Name of the Distributor who is representing himself as being authorized to carry and distribute manufacturer's brand or brands. If the distributor is listed in SEDS, the following will appear with all the pertinent information, such as: (1) The distributors' headquarters addresses, relevant phone, FAX numbers, e-mail address; (2) Links to all its products from authorized manufacturer or manufacturers that the dealers are authorized to distribute or sell; (3) Links to countries in which the indicated brand is authorized to be sold by a distributor in question; (4) Links to authorized retailers serviced by the said distributor, their physical addresses, phone, FAX numbers and e-mail addresses by each country; (5) Links to web sites on which each distributor and retailer is authorized to do business; (6) Helpful suggestions to assist the user in making a safe selection and purchase. If any of the first five SEDS-supplied items of information in paragraph C above do not agree with the actual situation with the distributor offering the product, it is an indication that: (a) the particular distributor is not authorized by the manufacturer to sell its product; or (b) the particular distributor is not authorized by the manufacturer to sell its product in certain location. This information will be relayed by SEDS to the user through a text displayed on monitor. Since a distributor may carry numerous products from various manufacturers, he can only advertise and sell products from those manufacturers certified and approved by the manufacturer and SEDS.

D. Name of the Certified retailers who represent themselves as being authorized to carry and distribute manufacturer's brand or brands. If the retailer is listed in SEDS, the following will appear with all the pertinent information, such as: (1) The retailer's headquarters address, relevant phone, FAX numbers, e-mail address; (2) Links to all its products from authorized manufacturers and distributors that the retailer is authorized to sell; (3) Links to countries in which the indicated brand is authorized to be sold by the retailer; (4) Links to web sites on which each retailer is authorized to do business. If any of the four SEDS-supplied items of information above do not agree with the actual situation with the retailer offering the product, it is an indication that the particular product is: (a) counterfeit or; (b) the particular retailer is not authorized by the manufacturer to sell the given product at the particular location or; (c) that the particular retailer is not certified by the manufacturer to sell its products. Since a retailer may carry numerous products from various manufacturers, he can only advertise and sell products from those manufacturers certified and approved by the manufacturer and SEDS.

E. Name of the product or catalog stock number of the product. This displays all relevant information on the product such as price, technical specifications and diagrams and serial numbers.

Once the go tab 156 is clicked, SEDS is directed to start the verification search of its data base on items A, B, C, D and E as typed into keyword or stock number box 154 and to preclude the possibility of “spelled alike” counterfeiting, whether by counterfeiting manufacturer's name or product's name. If there is a discrepancy in spelling between the user's spelling of the word or phrase based on the spelling in product advertising and the spelling provided by the manufacturer of the product to SEDS, SEDS will prompt the user to confirm the spelling. It is possible to have a case of honest typographical error by the vendor in the spelling of the product. However, a similar misspelled product brand advertised by numerous vendors, SEDS will indicate a counterfeit, with text: “No such product listed” since the SEDS' algorithm will track identically misspelled product names among various vendors as provided by users making a query, and flag and generate an alarm as being counterfeit if more than one vendor advertises similarly misspelled product. This is why a confirmation of the spelling by the manufacturer is necessary. If there is no discrepancy in spelling, SEDS will indicate by text that no discrepancy has been found based on the word or a phrase submitted by the user and that the user is advised to use other search buttons or links for a confirmation, if further confirmation is wanted.

The home webpage 60 further includes a select one box 158 having a scroll bar 160 and an associated go tab 162 for directing action by SEDS. The scroll bar 160 scrolls and displays: (a) Telephone area code; (b) Mail code or ZIP; (c) Region; (d) Country; (e) State or Province; (f) City or locality; (g) Retailer; (h) Distributor; and (i) Manufacturer. By clicking on any one display, MANUFACTURER for example, a blank field is provided for the user to fill with the name of the manufacturer. Upon filling the blank field and clicking on the go tab 162, SEDS displays all the information pertaining to the entered manufacturer information. If the entered manufacturer's name is not in SEDS records, or not registered under the name provided by user, it will indicate by text message appropriately. While similar to keyword or stock number box 154, the select one box 158 is primarily intended for the user to make product verification.

The home webpage 60 further includes a contact us tab 164 with standardized fields which includes integrated anti-spam capabilities, allowing user to communicate with SEDS regarding business transaction issues, detected piracy or counterfeit issues or verification of products and vendors. This information is routinely shared by SEDS with the affected manufacturer or the manufacturers if information is of common concern. Clicking on e-mail us option, within the contact us tab 164, the tab is expanded and additional folders are provided. These folders, as partially listed below, assist the SEDS to operate as a comprehensive, and diverse industrial supply catalog. The contact us tab 164 further provides the ability to request generic information including: (A) ABOUT US; (B) BULK ORDER FORM; (C) CATALOG REQUEST; (D) COMPANY INFORMATION; (E) CAREERS with SEDS; (F) SEDS' COMMUNITY, PRESS and INVESTOR RELATIONS; (G) CUSTOMER ORDER STATUS and SUPPORT; (H) ORDER HISTORY; (I) RETURNS; (J) SITE FEATURES; (K) WILL CALL; (L) WORLDWIDE SUPPLIER OVERVIEW; (M) CLEARANCE and REBATES DEPARTMENT; (N) TODAY'S SPECIALS; (O) SEDS' WEB SEMINARS; (P) ON-LINE PURCHASING SOLUTIONS; (Q) SEDS' NEWSLETTER; (R) DISCLAIMERS; (S) CROSS-REFERENCE INFORMATION; (T) HOT BUYS; (U) EMERGENCY SERVICES; and (V) OTHERS.

The home webpage 60 further includes a manufactures tab 166 which provides a list of certified manufacturers who are SEDS-listed and appear in an alphabetical order. The manufacture's tab 166 includes a scroll bar 168 for selecting a particular manufacturer and a list of countries where it has representation, along with the country of origin is displayed or otherwise. This is similar to entering the name of a manufacturer in the keyword or stock number box 154. Alternatively, the name of the certified manufacturer may also be obtained by clicking on the countries tab 170. There should be no inconsistency in data derived from manufactures tab 166 and information obtained from the keyword or stock number box 154 and countries tab 170.

The home webpage 60 further includes a distributors tab 172, which provides a list of all the certified distributors or dealers who are listed and appear in an alphabetical order. The distributors tab 172 includes a scroll bar 174 for selecting a particular distributor and the countries where it has representation, along with the country of origin is displayed. This is similar to entering the name of a distributor in the keyword or stock number box 154. The name of the certified distributor may also be obtained by clicking on the countries tab 170. There should be no inconsistency in data derived from the distributors tab 172 and information obtained from the keyword or stock number box 154 and countries tab 168. If the distributor has its own catalog, user or customer may view such catalog but would not be able to purchase directly from the distributor without going through SEDS.

The home webpage 60 further includes a retailers tab 176, which provides a list of all the certified retailers and are listed in an alphabetical order. The retailer's tab 167 includes a scroll bar 178 for selecting a particular retailer and countries where it has representation, along with the country of origin is displayed. This is similar to entering the name of a retailer in keyword or stock number box 154. If the retailer has its own catalog, user or customer may view such catalog but would not be able to purchase directly from the retailer without going through SEDS.

The home webpage 60 further includes a products tab 180, which provides a list of all the certified genuine products as sold from the vendors which are all certified as bona fide. The products tab 180 includes a scroll bar 182 for selecting a particular product. The SEDS' master catalog mirrors the individual catalogs of certified distributors and retailers. Some of the product catalog for example, listed alphabetically by industry in SEDS, are: (a) Electrical; (b) Electronics, civilian and military; (c) Manufacturing; (d) Pharmaceutical; (e) Chemical; (f) Transportation, land, air sea; (g) Raw materials; (h) Power transmission; etc. By scrolling and clicking on a particular product category a user is able to find detailed information on the specific product listed in the various sub-categories, their manufacturers, distributors and retailers as they are listed by countries.

The products tab 180 includes information dealing with particulars of ordering products, quantities, pricing, delivery dates, methods of payment and other transactional details. Examples of similar arrangements can be found at www.grainger.com. Such information may be similarly placed in other search tabs shown or described with reference to home webpage 60 or other webpage.

In greater detail, with respect to countries, by clicking on the countries tab 170, all the certified distributors and retailers are listed in an alphabetical order under the manufacturer, by country, also in the alphabetical order. Names of localities where the distributors and retailers market their certified products by other certified manufacturers, they would be listed accordingly. The countries tab 170 includes scroll bar 184 for clicking on a particular country, the cities or localities where the manufacturer has certified representation is displayed. While this is a redundant link which is similar to clicking on the keyword or number box 154 and the distributor tab 172 and retailer tab 176, it is necessary where the user is mainly interested in verifying the certified manufacturer, distributor or retailer in a specific country.

The home webpage 60 further includes a customer service tab 186, which is more order-specific than the general information provided in the contact us tab 164 and provides additional links to: (a) Order status; (b) General questions; (c) Web site support; (d) Product: support; (e) Help with SEDS accounts; Billing issues; (f) New SEDS features; Lost password; (g) Map and driving directions to nearest Manufacturer, Distributor or Retailer; and (h) Information for manufacturer, distributors, and retailers on becoming SEDS certified.

The home webpage 60 further includes: a) a terms of use tab 190 which provides additional information in sub-folders; and b) an official use only tab 300 which is intended mainly for Customs. The folders in the official use only tab 300 are not accessible to other SEDS users such as customers, distributors and retailers. The information on the official use only tab 300 is in the ‘pdf’ format and available also to the manufacturer, since it is the manufacturer who provides such information to the Customs at the same time as it is provided to SEDS. The official use tab 300 includes a scroll bar 301 and allows customs to be able to: Sign into SEDS; verify customer ID number; verify carrier number; verify shipper's number; verify Bill of Lading (.pdf); verify the Multi-Modal Transport Documents and any other required document. By comparing the product manifest and other accompanied import documents with the product document on SEDS, customs would be able to verify the authenticity of the shipment. Should the customs discover contraband item secreted among or within the product, it would be much easier to narrow the search for the source of contraband, down to production shift and hour.

The home webpage 60 further includes a terms of sale, license agreements and policies tab 196 with a model language binding on SEDS and all manufacturers, distributors and retailers doing business through SEDS, with respect to: a) Terms and Conditions of Sale folder, with a model language, b) View Service contract folder, with a model language, c) warranties folder, with a model language, d) return Policy folder, with a model language.

The home webpage 60 further includes an about SEDS tab 198, with model language, for describing attributes of SEDS.

The home webpage 60 further includes a legal disclaimer tab 200 with international and national recognized consumer regulations covering the sections below and binding on SEDS and all manufacturers, distributors and retailers doing business through SEDS. The legal disclaimer tab 200 supplements other SEDS tabs with: (A) PRIVACY POLICY folder, with a model language. (1) ABOUT SEDS ADS and E-MAILS sub-folder, with a model language. (2) MAILING LIST REMOVAL/CHANGE of ADDRESS sub-folder, with a model language. (3) HOW SEDS and OUR MANUFACTURERS, DISTRIBUTORS and RETAIL PARTNERS USE COOKIES and WEB BEACONS sub-folder, with a model language. (B) COPYRIGHT sub-folder, with a model language. (C) SEDS' PATENTS IN FORCE sub-folder, listing SEDS' patents. (D) PIRACY STATEMENT sub-folder, with a model language. (E) GLOBAL SOCIAL MEDIA POLICY sub-folder, with a model language. (F) ENCRYPTION sub-folder, with a model language. (U) SEDS' SUBMISSIONS POLICY sub-folder, with possible model language: “All remarks, suggestions, ideas, graphics or other information communicated to SEDS through this Site will forever be the property of SEDS. Unless otherwise specified in writing, all material submitted to SEDS will be presumed to be public and SEDS will not be required to treat the information as confidential. SEDS shall have exclusive ownership of all present and future existing rights in the information, without compensation to the person sending the information”.

The home webpage 60 further includes a terms of access and use tab 202 with possible model language: “Access to this Web site is limited to viewing the linked Web pages solely for legitimate business purposes to access the information provided by SEDS at this Web site. Any access or attempt to access other areas of the SEDS computer system or other information contained on the system for any purposes is strictly prohibited. You may not use any information contained on this Web site other than in connection with a legitimate business purpose”.

The home webpage 60 further includes a copyright notice tab 204, which describes rights asserted by the system 10, owners 36, manufacturers 38 or otherwise.

In greater detail, with respect to the official use only tab 300 shown in FIG. 3, in one exemplary embodiment upon clicking the tab the customs agent is directed to a customs webpage 302. Referring to FIG. 6, the customs webpage 302 provides the ability for custom agents to enter into SEDS information pertaining to the product. Upon arriving at the customs webpage 302, the custom agent logs in by entering information into an officer user ID box 304 and officer password box 306. The custom agent then enters other information pertaining to the shipment of the product. For example, the customs agent can enter information into customer ID box 308, carrier number box 310, carrier reference number box 312, shipper's number box 314, shipper's name and container ID box 316, bill of lading (.pdf) box 318, multi-modal transport documents box 320, or other documents box 322. At any time a user can return to home page 60 by clicking home tab 188. Any discrepancy between information provided by SEDS and documents with shipment should raise the alert flag with customs officer.

As previously mentioned, the authentication system 10 allows various users to enter information pertaining to distribution of products along a distribution chain. Referring again to FIG. 3, the SEDS home webpage 60 includes a distribution-product receipt confirmation tab 400 for providing users, particularly parties along the distribution chain the ability to input product information of received products. Upon clicking the confirmation tab 400, the user is directed towards the product receipt confirmation webpage 402. Through this page the user can input receipt information of products including the product quantity, trademarks, where the product came from (i.e. the link above the user in the distribution chain) any identification of the product including lot numbers, unique ID numbers, or otherwise as described herein. Should the information be different than what was inputted and authorized by the owner 36 and manufacturer 38, an alarm is generated as described with respect to FIG. 1C. This puts the owner 36 or manufacturer 38 on notice that an anomaly has occurred indicating potentially that a counterfeit or other unauthorized product has entered the distribution chain.

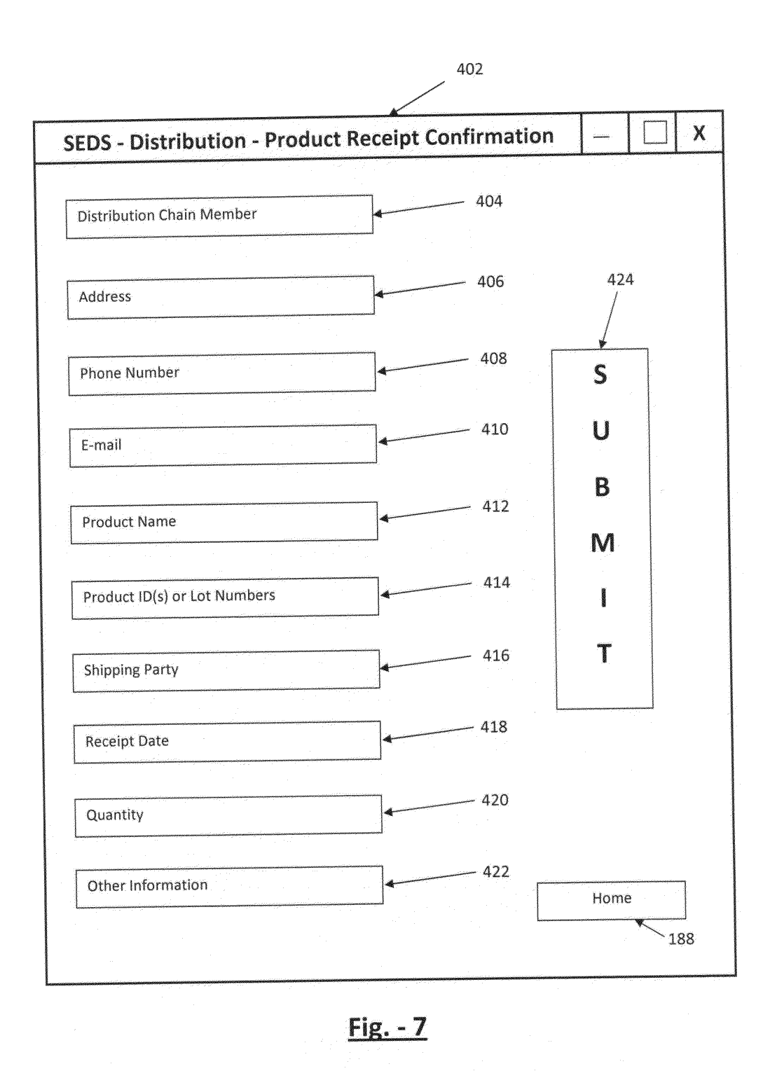

In greater detail, with respect to the product receipt confirmation webpage 402 shown in FIG. 7, the user enters information into boxes pertaining to receipt of product. This information is entered into: distribution chain member name box 404, address box 406, phone number box 408, e-mail box 410, product name box 412, product ID(s) or lot numbers box 414, shipping party box 416, receipt date box 418, quantity box 420, other information box 422. It should be appreciated that other information boxes may be used. Upon completion, the user clicks the submit box 424 which causes the information to be submitted to SEDS 12 and analyzed by SEDS programming, as described herein, for potential anomalies. Upon completion, or prior to completion, the user can return to the home webpage 60 by clicking home tab 188.

As mentioned herein, SEDS 12 monitors queries sent by purchasers of the products and information submitted by participants along the distribution chain. In one exemplary embodiment, referring again to FIG. 3, SEDS also provides the ability of consumers to manually transmit alarms to SEDS, which may be directed or relayed to owners 36 and manufacturers 38, indicating that they know or believe that the product they purchased or are about to purchase is counterfeit or at a minimum unauthorized for sale. Also, SEDS provides the ability for a user to register a purchased product.

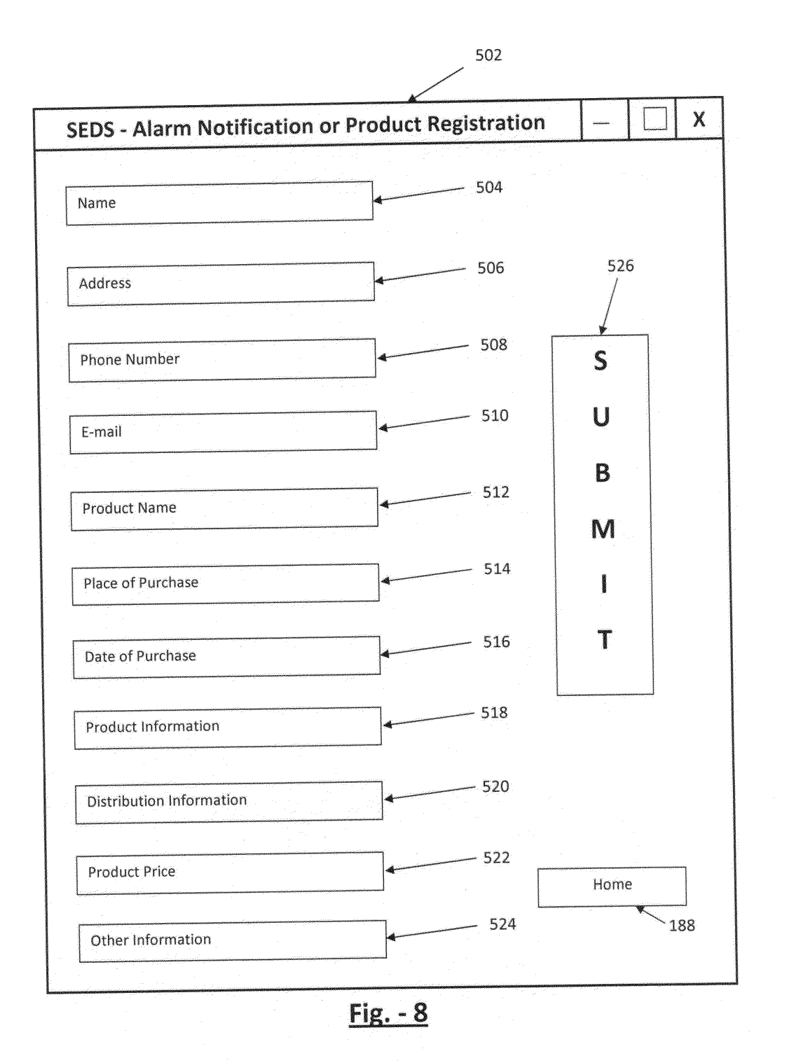

With respect to these advantageous, in one configuration, the home page 60 provides an alarm notification or product registration tab 500. The alarm notification or product registration tab 500 directs a user to an alarm notification or product registration webpage 502, in FIG. 8, which as with the distribution-product receipt confirmation page 402, allows a user to enter in information pertaining to a particular product and more particularly a product that has been purchased or about to be purchased. The alarm notification or product registration webpage 502 includes the following boxes in which information can be entered and submitted to SEDS 12: purchasers name box 504, address box 506, phone number box 508, e-mail box 510, product name box 512, place of purchase box 514, date of purchase box 516, product information box 518, distribution information box 520, product price box 522, other information box 524 or otherwise. Upon completion, the user clicks the submit box 526 which causes the information to be submitted to SEDS 12 and analyzed by SEDS programming, as described herein, for potential anomalies or for transmitting an appropriate alarm to the owner 36 or manufacturer 38. Upon completion, or prior to completion, the user can return to the home webpage 60 by clicking home tab 188.

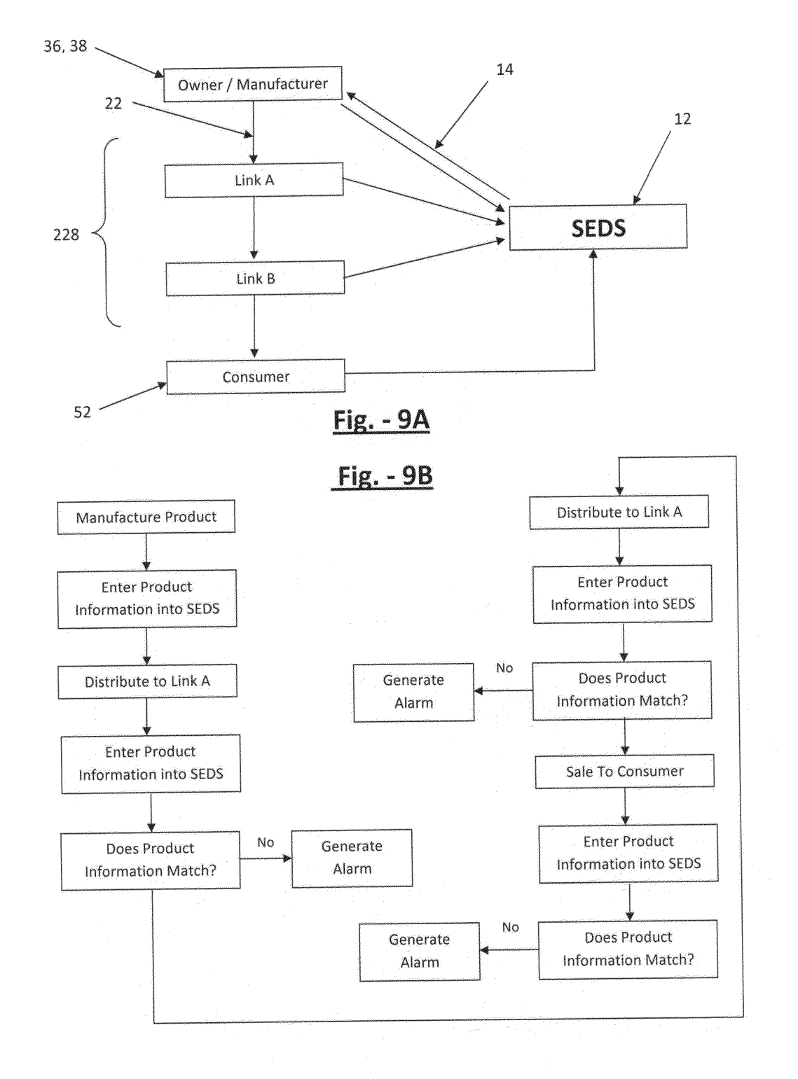

In one exemplary embodiment, referring to FIGS. 9A and 9B and in view of the forgoing, the present invention further includes a product authentication process for a distribution chain 228. In general, referring to FIG. 9a, the owner 36 and/or manufacturer 38 provides a product along a distribution chain 228 through a plurality of links, Link A, Link B, etc. Such links may comprise any of a distribution chain, as discussed herein or otherwise, such as distributor or dealer 42, shipper or carrier 44, customs 48, retailers 50 or otherwise, which distributes products that are eventually consumed by consumer 52. Prior to distribution, the owner 36 and/or manufacture 38 enters product information into SEDS 12 including distribution amount, ID numbers or references for lots or specific products and other information as described therein or otherwise. As the various links receives product they enter in information into SEDS pertaining to the product that is received, including number of products received, ID numbers or references for lots or specific products or other information. Similarly, once the product is received by the consumer 52, the consumer registers or confirms authenticity of the product. Any anomaly along the distribution chain 228 or consumer 52 and SEDS 12 generates an alarm that is received by the owner 36 or manufacturer 38.

Referring to FIG. 9B, a flow chart of the process of FIG. 9A is shown. As shown, the process includes manufacture of a product. Information of the product is entered into SEDS 12, such as distribution amount, ID numbers or references for lots or specific products and other information whereas the information provided by owner 36 or manufacturer 38 to SEDS 12 is treated by SEDS as a “master data” against which all other data from the outside world is compared by SEDS. The products are distributed along the distribution chain 228, wherein at each link the information pertaining to the product is entered into SEDS. If SEDS determines an anomaly exists between product number received, shipped, ID numbers or references for lots or specific products and other information, then an alarm is generated that is received by the owner 36 or manufacturer 38. This process is repeated down the entire distribution chain 228 until the product reaches the consumer 52. The consumer then has not only the ability, but is enticed, through packaging, trademarks, rebates, or otherwise, to log into SEDS and verify the authenticity of the product. Again, if SEDS determines an anomaly exists between product number received, shipped, ID numbers or references for lots or specific products and other information, then an alarm is generated that is received by the owner 36 or manufacturer 38. It should be appreciated that more or fewer steps may be involved.

While the invention has been described with reference to a preferred embodiment it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A product authentication method for distribution chains, the method comprising:
providing an internet accessible user interface configured for allowing different owners, manufacturers or both to enter in product information and distribution information of one or more products, the internet accessible user interface being in communication with one or more digital storage devices configured for storing a digital database of product information and distribution information;
inputting product information of a plurality of products into the digital database through the internet accessible user interface, the product information including identification information of the plurality of products;
inputting distribution information of the plurality of products into the digital database through the internet accessible user interface, the distribution information including anticipated locations of each of the plurality of products along a distribution chain having members from the owners, manufacturers or both to customers of the plurality of products;
providing access to the internet accessible user interface to members of the distribution chain to allow members of the distribution chain to:
confirm authenticity of other members of the distribution chain,
view product information and distribution information of products received from the other members of the distribution chain, and
submit information pertaining to products received from other members of the distribution chain; and
generating an alarm if a difference exists between the product information or the distribution information submitted by the owners, manufacturers, or both and other members of the distribution chain.

2. The method of claim 5, wherein members of the distribution chain includes shippers, distributor, retailers and customers.

3. The method of claim 1, wherein the product information includes a unique ID for each of the plurality of products.

4. The method of claim 1, wherein the distribution information includes a total number of products produced by a manufacturer.

5. The method of claim, wherein the distribution information includes the total number of products to be distributed to each member of the distribution chain.

6. The method of claim 1, wherein the internet accessible user interface is configured to generate a listing of manufacturers used to produce the plurality of products, a listing of distributors used to distribute the plurality of products and a listing of retailers used to sell the plurality of products in response to requests by members of the distribution chain.

7. The method of claim 1, wherein the internet accessible user interface is configured to indicate the manufacturer, distributor and retailer for each of the plurality of products based upon a unique ID number or lot number.

8. The method of claim 1, wherein the internet accessible user interface provides means for distributors, retailers or both to enter receipt information of products including number of products received, lot numbers of products received, unique ID numbers of products received or combinations thereof.

9. The method of claim 1, wherein generation of the alarm is based upon a comparison between the total number of products anticipated to be received by a member of the distribution list, as entered by an owner or manufacturer of the products, and the total number of products actually received by the member, as submitted by members of the distribution chain.

10. The method of claim 1, wherein the internet accessible user interface provides means for a member of the distribution chain to input or search for a unique ID number of a product to confirm authenticity thereof.

11. The method of claim 1, wherein the internet accessible user interface provides means for a member of the distribution chain to input or search for membership information of others to confirm authenticity of the member.

12. The method of claim 11, wherein generation of the alarm is based upon a comparison between inputted or searched membership query submitted by a member of the distribution chain and authorized members of the distribution chain.

13. A product authentication and alarm system, comprising:
an internet accessible user interface configured for allowing different owners, manufacturers or both to enter in product information and distribution information of one or more products, the internet accessible user interface being in communication with one or more digital storage devices configured for storing a digital database of product information and distribution information
a first digital database including product information of a plurality of products, the first digital database includes information capable of identifying one or a group of the plurality of products, the first digital database being accessible through the internet accessible user interface;
a second digital database including distribution information of the plurality of products, the second digital database indicating anticipated locations of each of the plurality of products along a distribution chain having members from the owners, manufacturers or both to customers of the plurality of products, the second digital database being accessible through the internet accessible user interface,
wherein access to the internet accessible user interface is provided to members of the distribution chain to allow members of the distribution chain to:
confirm authenticity of other members of the distribution chain,
view product information and distribution information of products received from the other members of the distribution chain, and
submit information pertaining to products received from other members of the distribution chain; and
an alarm system configured to notify the owner, manufacturer or both if a difference exists between the product information or the distribution information submitted by the owners, manufacturers, or both and other members of the distribution chain.

21. The system of claim 13, wherein the distribution information includes the total number of products to be distributed to each member of the distribution chain.

22. The system of claim 13, wherein the internet accessible user interface is configured to generate a listing of manufacturers used to produce the plurality of products, a listing of distributors used to distribute the plurality of products and a listing of retailers used to sell the plurality of products in response to requests by members of the distribution chain.

23. The system of claim 13, wherein the internet accessible user interface is configured to indicate the manufacturer, distributor and retailer for each of the plurality of products based upon a unique ID number or lot number.

24. The system of claim 13, wherein the internet accessible user interface provides means for distributors, retailers or both to enter receipt information of products including number of products received, lot numbers of products received, unique ID numbers of products received or combinations thereof.

25. The system of claim 13, wherein generation of the alarm is based upon a comparison between the total number of products anticipated to be received by a member of the distribution list, as entered by an owner or manufacturer of the products, and the total number of products actually received or possessed by the member, as submitted by members of the distribution chain.

26. The system of claim 13, wherein the internet accessible user interface provides means for a member of the distribution chain to input or search for a unique ID number of a product to confirm authenticity thereof.

27. The system of claim 13, wherein the internet accessible user interface provides means for a member of the distribution chain to input or search for membership information of others to confirm authenticity of the member.
